(19) United States
(12) Patent Application Publication
(10) Pub. No.: US 2021/0036774 A1
(43) Pub. Date: Feb. 4, 2021

(54) OPTICAL TRANSMISSION DEVICE, OPTICAL RECEPTION DEVICE, AND OPTICAL COMMUNICATION METHOD

(71) Applicant: NEC Corporation, Tokyo (JP)

(72) Inventor: Mitsunori MURAKI, Tokyo (JP)

(73) Assignee: NEC Corporation, Tokyo (JP)

(21) Appl. No.: 16/968,212

(22) PCT Filed: Feb. 5, 2019
(86) PCT No.: PCT/JP2019/004053

§ 371 Date: Aug. 7, 2020

(30) Foreign Application Priority Data
Feb. 8, 2018 (JP) 2018-020995

(51) Int. Cl. H04B 10/07; H04B 10/61; H04B 10/572; H04B 10/516

(52) U.S. Cl. CPC H04B 10/07; H04B 10/5161; H04B 10/572; H04B 10/61

(57) ABSTRACT

An optical communication method includes: outputting light of a frequency allocated to an own device; separating the output light into mutually orthogonal polarized waves, modulating an in-phase component and a quadrature component in each of the polarized waves, and outputting an optical signal acquired by polarization synthesis of modulated component waves; acquiring information on a reception state of the optical signal in an optical reception device being a transmission destination of the optical signal; and controlling, based on the information on the reception state, a frequency of the light to be output, and adjusting a frequency offset being a difference between the frequency of the light to be output and a frequency of local oscillation light for use in coherent detection of the optical signal by the optical reception device.

### TECHNICAL FIELD

The present invention relates to an optical communication technique of a digital coherent scheme, and particularly, relates to a technique for maintaining reception quality.

### BACKGROUND ART

A digital coherent optical communication scheme is used as an optical communication technique capable of high-speed and large-capacity transmission. For the digital coherent optical communication scheme, various modulation schemes such as a polarization multiplexing scheme and a multilevel modulation scheme have been proposed. As the multilevel modulation scheme, for example, binary phase shift keying (BPSK), quadrature phase shift keying (QPSK), 8-quadrature amplitude modulation (8QAM), or the like is used.

In a digital coherent scheme, a baseband signal is generated by multiplying a received optical signal by output light (local oscillation light) from a local oscillator. An original transmission signal is reproduced by analog-to-digital converting the baseband signal and performing digital signal processing. Thus, it is necessary to stably perform coherent detection of an optical signal in order to maintain reception quality. As such a technique for stably performing coherent detection of an optical signal and maintaining signal quality, for example, a technique as in PTL 1 is disclosed.

PTL 1 relates to an optical transmission device of the digital coherent scheme. The optical transmission device in PTL 1 adjusts a wavelength and power of local oscillation light in such a way as to increase signal quality of a reception signal, and controls the wavelength of the local oscillation light in such a way as not to generate a wavelength difference between an optical signal and the local oscillation light. PTL 1 having such a configuration is able to achieve high-precision optical signal reception performance. Similarly, PTLs 2 and 3 also disclose a technique relating to an optical transmission device of the digital coherent scheme.

### CITATION LIST

### Patent Literature

[PTL 1] Japanese Unexamined Patent Application Publication No. 2015-170916

[PTL 2] International Publication WO 2012/132374

[PTL 3] Japanese Unexamined Patent Application Publication No. 2015-171083

### SUMMARY OF INVENTION

### Technical Problem

However, the technique in PTL 1 is insufficient in a point as follows. In the case of performing the coherent detection on a reception side, when a frequency of an optical signal is consistent with a frequency of local oscillation light, a symbol may be possibly fixed onto an in-phase (I) axis or a quadrature (Q) axis. In such a case, when a gain is controlled automatically in such a way that output amplitude becomes constant in an optical signal detection element, the gain may be set large in order to increase the output amplitude, because of absence of an input signal in a 0-component of a component in a state of being fixed onto the axis. When the gain is set large, noise in a signal increases, and quality degradation of the signal is generated. Similarly, the technique in PTLs 2 and 3 is also insufficient as a technique for preventing quality degradation of a signal. Thus, the techniques in PTLs 1, 2, and 3 are insufficient as a technique for maintaining reception quality with which stable reception processing can be performed in an optical communication system of the digital coherent scheme.

In order to solve the above-described problem, an object of the present invention is to provide an optical transmission device capable of maintaining reception quality with which stable reception processing can be performed.

### Solution to Problem

In order to solve the above-described problem, an optical transmission device according to the present invention includes light output means, light modulation means, reception information acquisition means, and frequency adjustment means. The light output means outputs light of a frequency allocated to the optical transmission device. The light modulation means separates the light output by the light output means into mutually orthogonal polarized waves, modulates an in-phase component and a quadrature component in each of the polarized waves, and outputs an optical signal acquired by polarization synthesis of modulated component waves. The reception information acquisition means acquires information on a reception state of the optical signal in an optical reception device being a transmission destination of the optical signal. The frequency adjustment means controls, based on the information on the reception state, a frequency of the light to be output by the light output means, and adjusts a frequency offset being a difference between the frequency of the light output by the light output means and a frequency of local oscillation light for use in coherent detection of the optical signal by the optical reception device.

An optical communication method according to the present example embodiment includes outputting light of a frequency allocated to an own device, separating the output light into mutually orthogonal polarized waves, modulating an in-phase component and a quadrature component in each of the polarized waves, and outputting an optical signal acquired by polarization synthesis of modulated component waves. The optical communication method according to the present example embodiment includes acquiring information on a reception state of the optical signal in an optical reception device being a transmission destination of the optical signal. The optical communication method according to the present example embodiment includes controlling, based on the information on the reception state, a frequency of the light to be output, and adjusting a frequency offset being a difference between the frequency of the light output and a frequency of local oscillation light for use in coherent detection of the optical signal by the optical reception device.

### Advantageous Effects of Invention

The present invention enables stable coherent detection on a reception side and quality maintenance of a reception signal.

### BRIEF DESCRIPTION OF DRAWINGS

FIG. 1 is a diagram illustrating an overview of a configuration according to a first example embodiment of the present invention.

FIG. 2 is a diagram illustrating an overview of a configuration according to a second example embodiment of the present invention.

FIG. 3 is a diagram illustrating a configuration of an optical transmission device according to the second example embodiment of the present invention.

FIG. 4 is a diagram illustrating a configuration of an optical reception device according to the second example embodiment of the present invention.

FIG. 5 is a diagram illustrating operation flow of an optical communication system according to the second example embodiment of the present invention.

FIG. 6 is a diagram illustrating an example of a result of measuring the number of errors for each frequency offset according to the second example embodiment of the present invention.

FIG. 7 is a diagram illustrating an example of a frame transmitted in an example of another configuration according to the second example embodiment of the present invention.

FIG. 8 is a diagram illustrating an example of a constellation in a multilevel modulation scheme.

FIG. 9 is a diagram illustrating an example of shifting of the constellation in the multilevel modulation scheme.

FIG. 10 is a diagram illustrating an overview of a configuration according to a third example embodiment of the present invention.

FIG. 11 is a diagram illustrating a configuration of an optical transmission device according to the third example embodiment of the present invention.

FIG. 12 is a diagram illustrating a configuration of an optical reception device according to the third example embodiment of the present invention.

FIG. 13 is a diagram illustrating an overview of a configuration according to a fourth example embodiment of the present invention.

FIG. 14 is a diagram illustrating a configuration of an optical transmission device according to the fourth example embodiment of the present invention.

FIG. 15 is a diagram illustrating a configuration of an optical reception device according to the fourth example embodiment of the present invention.

FIG. 16 is a diagram illustrating operation flow of an optical communication system according to the fourth example embodiment of the present invention.

FIG. 17 is a diagram illustrating an overview of a configuration according to a fifth example embodiment of the present invention.

FIG. 18 is a diagram illustrating a configuration of an optical transmission device according to the fifth example embodiment of the present invention.

FIG. 19 is a diagram illustrating a configuration of an optical reception device according to the fifth example embodiment of the present invention.

FIG. 20 is a diagram illustrating an overview of a configuration according to a sixth example embodiment of the present invention.

FIG. 21 is a diagram illustrating a configuration of an optical transmission device according to the sixth example embodiment of the present invention.

FIG. 22 is a diagram illustrating a configuration of an optical reception device according to the sixth example embodiment of the present invention.

FIG. 23 is a diagram illustrating operation flow of an optical communication system according to the sixth example embodiment of the present invention.

FIG. 24 is a diagram illustrating an overview of a configuration according to a seventh example embodiment of the present invention.

FIG. 25 is a diagram illustrating a configuration of an optical transmission device according to the seventh example embodiment of the present invention.

FIG. 26 is a diagram illustrating a configuration of an optical reception device according to the seventh example embodiment of the present invention.

### EXAMPLE EMBODIMENT

### First Example Embodiment

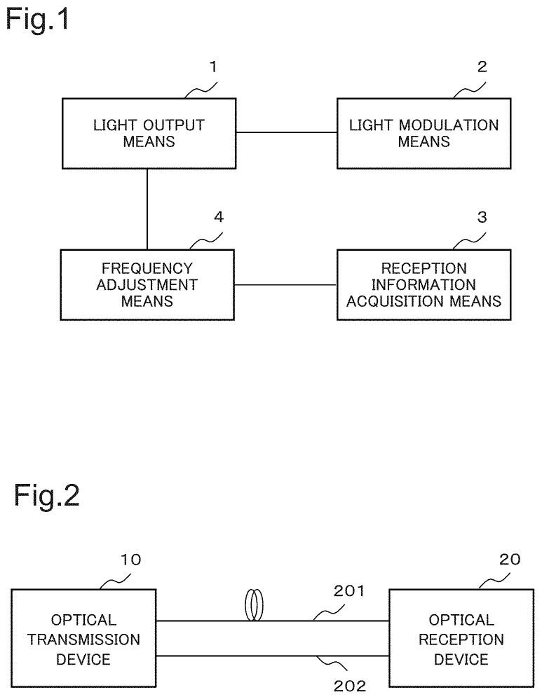

A first example embodiment of the present invention will be described in detail with reference to the drawings. FIG. 1 illustrates an overview of a configuration of an optical transmission device according to the present example embodiment. The optical transmission device according to the present example embodiment includes light output means 1, light modulation means 2, reception information acquisition means 3, and frequency adjustment means 4. The light output means 1 outputs light of a frequency allocated to an own device. The light modulation means 2 separates the light output by the light output means 1 into mutually orthogonal polarized waves, modulates an in-phase component and a quadrature component in each of the polarized waves, and outputs an optical signal acquired by polarization synthesis of modulated component waves. The reception information acquisition means 3 acquires information on a reception state of the optical signal in an optical reception device being a transmission destination of the optical signal. The frequency adjustment means 4 controls, based on the information on the reception state, a frequency of the light output by the light output means 1, and adjusts a frequency offset being a difference between the frequency of the light output by the light output means 1 and a frequency of local oscillation light for use in coherent detection of the optical signal by the optical reception device.

In the optical transmission device according to the present example embodiment, the reception information acquisition means 3 acquires the information on the reception state of the optical reception device, and the frequency adjustment means 4 adjusts the frequency offset being the difference between the frequency of light output by the light output means 1 and the frequency of the local oscillation light of the optical reception device. In the optical transmission device according to the present example embodiment, no component having an output amplitude of 0 is generated in a signal detection element of the optical reception device, by adding an offset to the frequency of the light output by the light output means 1 and the frequency of the local oscillation light. This can prevent a state where noise is generated in a signal in order to increase a gain in the optical reception device, and thus, reception quality can be maintained. Consequently, use of the optical transmission device according to the present example embodiment enables stable coherent detection on a reception side and quality maintenance of a reception signal.

### Second Example Embodiment

A second example embodiment of the present invention will be described in detail with reference to the drawings. FIG. 2 is a diagram illustrating an overview of a configuration of an optical communication system according to the present example embodiment. The optical communication system according to the present example embodiment includes an optical transmission device 10 and an optical reception device 20. The optical transmission device 10 and the optical reception device 20 are connected to each other via a communication channel 201 and a communication channel 202. The optical communication system according to the present example embodiment is a network system that performs optical communication of the digital coherent scheme between the optical transmission device 10 and the optical reception device 20 via the communication channel 201.

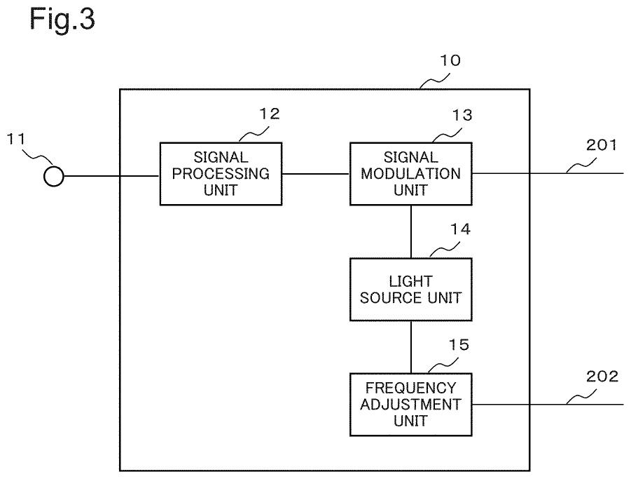

A configuration of the optical transmission device 10 will be described. FIG. 3 illustrates the configuration of the optical transmission device 10 according to the present example embodiment. The optical transmission device 10 includes a client signal input unit 11, a signal processing unit 12, a signal modulation unit 13, a light source unit 14, and a frequency adjustment unit 15.

The client signal input unit 11 is an input port for a client signal transmitted via the communication channel 201. A client signal input to the client signal input unit 11 is sent to the signal processing unit 12.

The signal processing unit 12 performs processing such as redundancy processing on the input client signal, and maps the client signal on a frame for use in transmission through the communication channel 201

The signal modulation unit 13 modulates, based on a signal input from the signal processing unit 12, light input from the light source unit 14, and generates an optical signal to be transmitted to the communication channel 201. The signal modulation unit 13 according to the present example embodiment performs modulation by using, for example, a binary phase shift keying (BPSK) modulation scheme. The modulation scheme may be another multilevel modulation scheme other than BPSK, such as quadrature phase shift keying (QPSK) or 8-quadrature amplitude modulation (8QAM). A function of the signal modulation unit 13 according to the present example embodiment is equivalent to the light modulation means 2 according to the first example embodiment.

The light source unit 14 outputs continuous light of a predetermined frequency to the signal modulation unit 13. The predetermined frequency is allocated based on wavelength design of an optical communication network. By setting the predetermined frequency as a set value, the light source unit 14 outputs light of a frequency with an offset added to the set value. Frequency offset quantity is controlled by the frequency adjustment unit 15. A function of the light source unit 14 according to the present example embodiment is equivalent to the light output means 1 according to the first example embodiment.

The frequency adjustment unit 15 controls the frequency offset quantity for the light source unit 14. The frequency adjustment unit 15 controls the frequency offset quantity, based on error information sent from the optical reception device 20. The frequency adjustment unit 15 controls the frequency offset quantity in such a way as to decrease a bit error rate (BER) sent as the error information. A function of the frequency adjustment means 4 according to the present example embodiment is equivalent to the reception information acquisition means 3 and the frequency adjustment means 4 according to the first example embodiment.

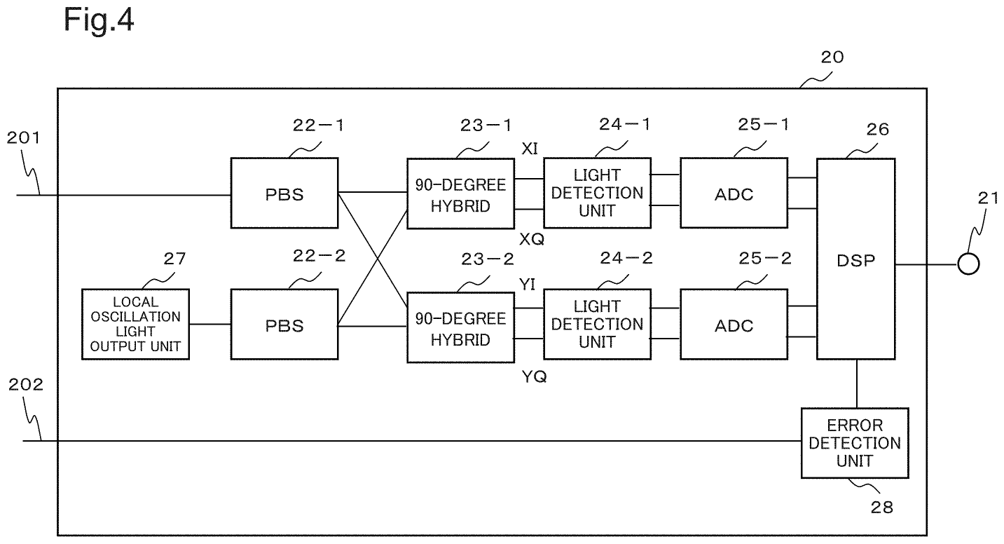

A configuration of the optical reception device 20 will be described. FIG. 4 illustrates the configuration of the optical reception device 20 according to the present example embodiment. The optical reception device 20 includes a client signal output unit 21, a PBS 22, a 90-degree hybrid 23, and a light detection unit 24. The optical reception device 20 further includes an analog-to-digital converter (ADC) 25, a digital signal processor (DSP) 26, a local oscillation light output unit 27, and an error detection unit 28.

The client signal output unit 21 is an output port for outputting a demodulated client signal.

The polarizing beam splitter (PBS) 22 polarization-separates and outputs an input optical signal. The PBS 22 includes a PBS 22-1 that polarization-separates an optical signal, and a PBS 22-2 that polarization-separates local oscillation light. The PBS 22-1 polarization-separates the optical signal input from the communication channel 201, outputs an X-polarized wave to a 90-degree hybrid 23-1, and sends a Y-polarized wave to a 90-degree hybrid 23-2. The PBS 22-2 polarization-separates light input from the local oscillation light output unit 27, outputs an X-polarized wave to the 90-degree hybrid 23-1, and sends a Y-polarized wave to the 90-degree hybrid 23-2.

The 90-degree hybrid 23 combines the input optical signal with the local oscillation light through two paths having phases different by 90 degrees. The 90-degree hybrid 23-1 combines an X-polarized wave component of the optical signal input from the PBS 22-1 with an X-polarized wave component of the local oscillation light input from the PBS 22-2 through the two paths having phases different from each other by 90 degrees.

The 90-degree hybrid 23-1 sends, to a light detection unit 24-1, signals of in-phase (I) and quadrature (Q) components generated by combining the optical signal with the local oscillation light through the paths having phases different by 90 degrees. The 90-degree hybrid 23-2 combines a Y-polarized wave component of the optical signal input from the PBS 22-1 with a Y-polarized wave component of the local oscillation light input from the PBS 22-2 through the two paths having phases different from each other by 90 degrees. The 90-degree hybrid 23-2 sends, to a light detection unit 24-2, signals of I- and Q-components generated by combining the optical signal with the local oscillation light through the paths having phases different by 90 degrees.

The light detection unit 24 converts the input optical signal into an electrical signal, and outputs the electrical signal. The light detection unit 24 is configured by using a photodiode. The light detection unit 24-1 converts, into electrical signals, the optical signals of X-polarized I- and Q-components input from the 90-degree hybrid 23-1, and sends the electrical signals to an ADC 25-1. The light detection unit 24-2 converts, into electrical signals, the optical signals of Y-polarized I- and Q-components input from the 90-degree hybrid 23-2, and sends the electrical signals to an ADC 25-2.

The ADC 25 converts an input analog signal into a digital signal. The ADC 25-1 converts an analog signal input from the light detection unit 24-1 into a digital signal, and sends the digital signal to the DSP 26. The ADC 25-2 converts an analog signal input from the light detection unit 24-2 into a digital signal, and sends the digital signal to the DSP 26.

The DSP 26 demodulates the client signal by performing reception processing such as distortion correction, decoding, and error correction of the input signal. The DSP 26 is configured by a semiconductor device. A reception processing function of the DSP 26 may be configured by using a field programmable gate array (FPGA). The reception processing function of the DSP 26 may be performed by execution of a computer program by a general-purpose processor such as a central processing unit (CPU). The DSP 26 sends the demodulated client signal to the client signal output unit 21.

The local oscillation light output unit 27 generates local oscillation light combined with the optical signal transmitted via the communication channel 201 and for use in generating an optical signal of an intermediate frequency. The local oscillation light output unit 27 includes a semiconductor laser, and outputs light of a frequency set based on a frequency of the optical signal transmitted via the communication channel 201.

The error detection unit 28 monitors error correction processing performed by the DSP 26, and measures the number of errors. The error detection unit 28 according to the present example embodiment calculates a BER, based on the measured number of errors, and sends, as error information, information on the calculated BER to the optical transmission device 10 via the communication channel 202. The error detection unit 28 may be integrated with the DSP 26 as a part of the DSP 26.

The communication channel 201 is configured as an optical communication network using an optical fiber. The communication channel 201 transmits an optical signal in a direction from the optical transmission device 10 to the optical reception device 20. The communication channel 202 is a communication network through which a control signal and the like is transmitted from the optical reception device 20 to the optical transmission device. The communication channel 202 is included as, for example, a line for control of devices by a communication management system.

An operation of the optical communication system according to the present example embodiment will be described. First, a client signal to be transmitted through the communication channel 201 is input to the client signal input unit 11. As the client signal, for example, a signal of Synchronous Optical Network (SONET), Ethernet (registered trademark), Fiber Channel (FC), Optical Transport Network (OTN), or the like is used. The client signal input to the client signal input unit 11 is sent to the signal processing unit 12.

Upon input of the client signal, the signal processing unit 12 maps the client signal on a frame for use in transmission through the communication channel 201. When mapping is performed, the signal processing unit 12 sends the mapped signal to the signal modulation unit 13.

Upon input of a signal based on data of the frame on which mapping is performed, the signal modulation unit 13 modulates light output from the light source unit 14, based on the data of the frame input from the signal processing unit 12. The signal modulation unit 13 performs conversion from an electrical signal into an optical signal by using a BPSK scheme. The signal modulation unit 13 transmits, to the communication channel 201, an optical signal generated by modulation.

The optical signal transmitted to the communication channel 201 is transmitted through the communication channel 201, and is sent to the optical reception device 20. The optical signal received by the optical reception device 20 is input to the PBS 22-1. Upon input of the optical signal, the PBS 22 polarization-separates the input optical signal, sends an X-polarized optical signal to the 90-degree hybrid 23-1, and sends a Y-polarized optical signal to the 90-degree hybrid 23-2.

Upon input of the optical signal from the PBS 22-1, the 90-degree hybrid 23-1 and the 90-degree hybrid 23-2 combine the optical signal input from the PBS 22-1 with local oscillation light input from the PBS 22-2, and generates a signal of an intermediate frequency associated with I- and Q-components. The 90-degree hybrid 23-1 and the 90-degree hybrid 23-2 send the generated optical signal of the intermediate frequency to the light detection unit 24-1 and the light detection unit 24-2.

Upon input of the optical signal, the light detection unit 24-1 and the light detection unit 24-2 convert the input optical signal into an electrical signal, and send the electrical signal to the ADC 25-1 and the ADC 25-2. Upon input of the electrical signal converted from the optical signal, the ADC 25-1 and the ADC 25-2 convert the input signal to a digital signal, and send the digital signal to the DSP 26.

Upon input of the signal to the DSP 26, the DSP 26 demodulates the client signal by performing reception processing on the input signal, and sends the demodulated client signal to the client signal output unit 21. The client signal output unit 21 outputs the input client signal to a communication network and a communication device.

When the reception processing is performed by the DSP 26, the error detection unit 28 monitors error correction processing performed by the DSP 26, and measures the number of errors in received signals. The error detection unit 28 according to the present example embodiment calculates the number of errors as a BER. When a BER is calculated, the error detection unit 28 sends, as error information, information on the calculated BER to the optical transmission device 10 via the communication channel 202.

The error information received by the optical transmission device 10 via the communication channel 202 is sent to the frequency adjustment unit 15. Upon reception of the error information, the frequency adjustment unit 15 adjusts a frequency offset of the light source unit 14 in such a way as to decrease a value of the BER. The frequency adjustment unit 15 changes frequency offset quantity, based on change in the BER, and controls the frequency offset quantity in such a way as to minimize the BER. The light source unit 14 outputs, to the signal modulation unit 13, light of a frequency having corrected offset quantity.

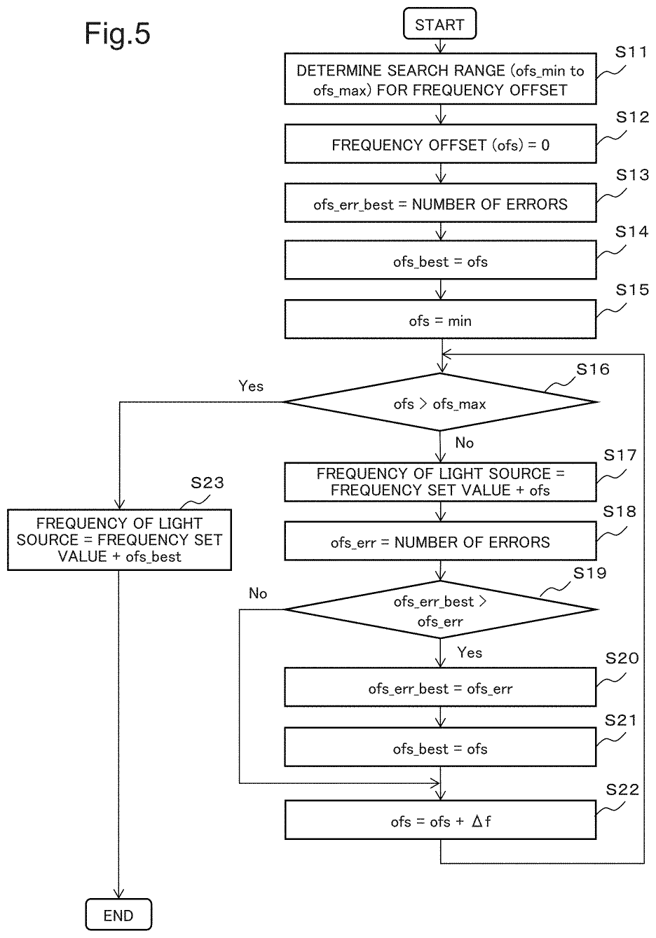

An operation when a frequency of light output by the light source unit 14 is adjusted by the optical transmission device 10 will be described in more detail. FIG. 5 illustrates operation flow when a frequency of light output by the light source unit 14 is adjusted.

First, the frequency adjustment unit 15 sets a search range of a frequency offset, that is, a range for changing frequency offset quantity in the case of finding a frequency to be output by the light source unit 14 when the number of errors is minimum (Step S11). The search range of the frequency offset may be preliminarily stored in the frequency adjustment unit 15, or a set value of the search range may be input by an operator or the like.

When the search range of the frequency offset is set, the frequency adjustment unit 15 sets a frequency offset ofs, that is, an amount of deviation from a set value for a frequency of light output from the light source unit 14, as ofs=0 (Step S12). When ofs=0, the light source unit 14 outputs the set value, that is, light of a frequency allocated to an own device.

The frequency adjustment unit 15 extracts, from error information received from the optical reception device 20, information on the number of errors, and substitutes the number of errors in the case of ofs=0 for a minimum value ofs_err_best of errors (Step S13). The frequency adjustment unit 15 substitutes a value of the set frequency offset ofs for ofs_best indicating information on a frequency offset associated with data substituted for the minimum value ofs_err_best (Step S14). When the number of errors in the case of ofs=0 is substituted for ofs_err_best, then ofs_best=0 holds.

When the number of errors in the case that the frequency offset is 0 is stored, the frequency adjustment unit 15 sets a set value of the frequency offset ofs to ofs=min, that is, a minimum value min of the search range of the frequency offset (Step S15).

When the value of the frequency offset ofs is set, the frequency adjustment unit 15 compares the set value of the frequency offset ofs with a maximum value ofs_max of the search range of the frequency offset. When the frequency offset ofs is equal to or less than the maximum value ofs_max (No in Step S16), the frequency adjustment unit 15 corrects a frequency of a light source, based on the frequency offset ofs. The frequency adjustment unit 15 calculates and sets a frequency to be output by the light source unit 14 as a frequency of the light source=a frequency set value+ofs (Step S17).

When the frequency of the light source unit 14 is set based on the frequency offset ofs, light of a frequency with an offset from the set value is output from the light source unit 14. When the light of the frequency with the offset is output to the communication channel 201, information on the number of errors is sent from the optical reception device 20 being a transmission destination.

Upon reception of the information on the number of errors, the frequency adjustment unit 15 substitutes the number of errors for ofs_err (Step S18), and compares the received number of errors ofs_err with ofs_err_best being stored as the hitherto minimum value. When the newly received number of errors is smaller (Yes in Step S19), the frequency adjustment unit 15 updates ofs_err_best with a value of the newly received number of errors ofs_err (Step S20). When ofs_err_best is updated, the frequency adjustment unit 15 substitutes the value of the frequency offset ofs for ofs_best indicating information on the frequency offset associated with the minimum value ofs_err_best (Step S21).

When the information on the frequency offset associated with the minimum value ofs_err_best is updated, the frequency adjustment unit 15 changes the frequency offset ofs as ofs=ofs+Δf (Step S22), and performs an operation from Step S16. Δf being an amount for changing the frequency offset is preliminarily set. Δf may be set by dividing the search range of the frequency offset by a preliminarily set number.

When the newly received number of errors is equal to or more than the hitherto minimum value (No in Step S19), the frequency adjustment unit 15 changes the frequency offset ofs as ofs=ofs+Δf (Step S22), and performs an operation from Step S16.

In Step S16, when the frequency offset ofs is more than the maximum value ofs_max of the search range (Yes in Step S16), the frequency adjustment unit 15 sets the frequency of the light source unit 14 to a frequency associated with the minimum value ofs_err_best. The frequency adjustment unit 15 calculates a frequency of the light source as a frequency of the light source=a frequency set value+ofs_best, and controls a frequency of a signal to be output by the light source unit 14, in such a way that the frequency becomes the calculated frequency (Step S23).

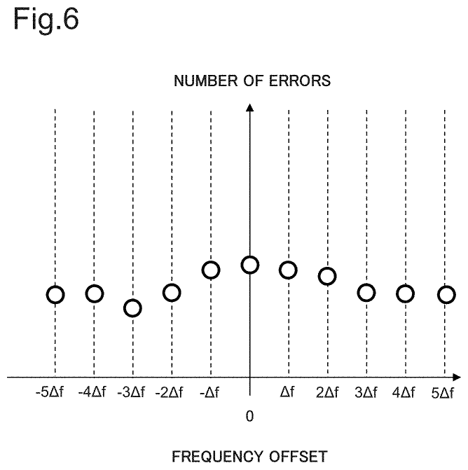

FIG. 6 is a graph illustrating an example of a relationship between frequency offset quantity and the number of errors. In the example in FIG. 6, the number of errors is measured by changing the frequency offset quantity for each Δf. In the example in FIG. 6, −3 Δf having the minimum number of errors is set as offset quantity for a frequency of light output by the light source unit 14.

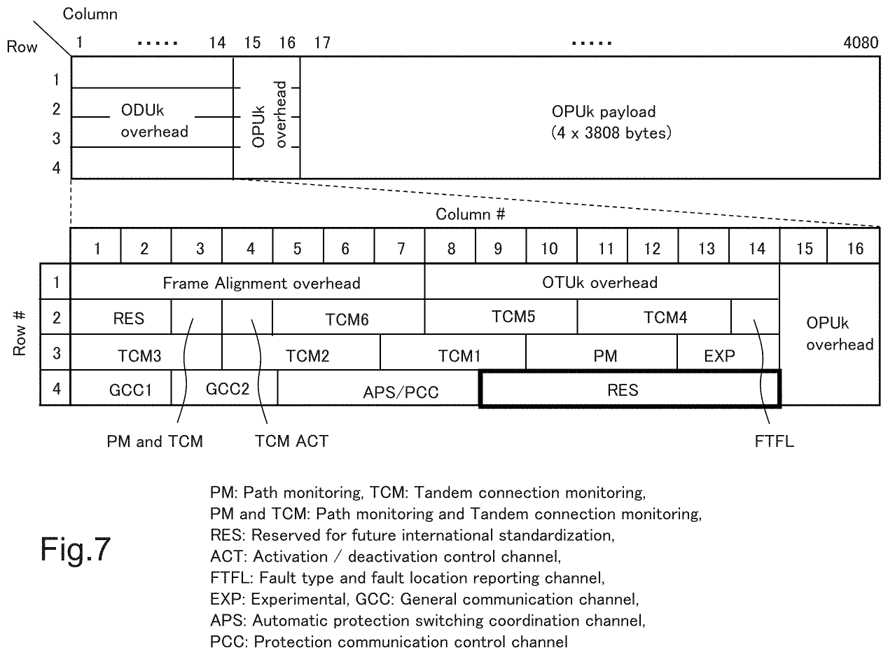

In the optical communication system according to the present example embodiment, error information is transmitted from the optical reception device 20 to the optical transmission device 10 via the communication channel 202. However, when bidirectional optical communication is performed, error information may be added to a frame to be sent as a main signal from the optical reception device 20 to the optical transmission device 10. FIG. 7 illustrates a configuration of an OTN frame. When data communication using the OTN frame as in FIG. 7 is performed, for example, error information can be sent from the optical reception device 20 to the optical transmission device 10 by adding the error information to a reserved bit in an overhead. Such a configuration eliminates need for communication using the communication channel 202, and thus, the configuration is simplified.

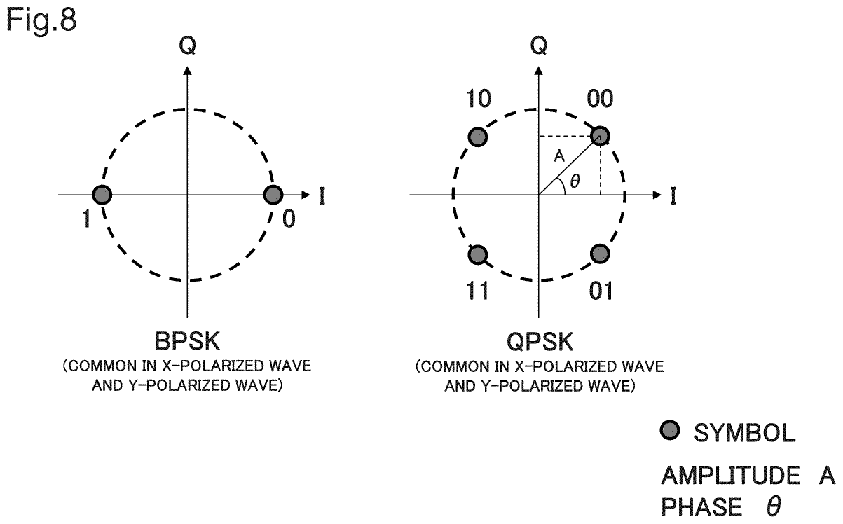

FIG. 8 is a diagram illustrating constellations when a BPSK modulation scheme and a QPSK modulation scheme are used. In the constellations in FIG. 8, symbols of signals are drawn on a plane, with an I axis representing a phase component in-phase with a carrier wave, and a Q axis representing a phase component orthogonal to the carrier wave. In the case of the BPSK modulation scheme, the symbols are mapped on the I axis. Thus, when a frequency offset for an optical signal and local oscillation light is small, which results in a state on the left side in FIG. 8, a Q-component of the optical signal becomes 0. In this state, when a gain is automatically controlled in such a way as to attain constant output amplitude of the light detection unit 24, no signal is input to Q-ch to which a signal of a Q-component is input, and thus, output amplitude does not increase upon amplification of a Q-ch signal. Thus, the gain is set large in order to increase the output amplitude of the Q-ch signal, a noise component is added to Q-ch, and degradation in signal quality is generated.

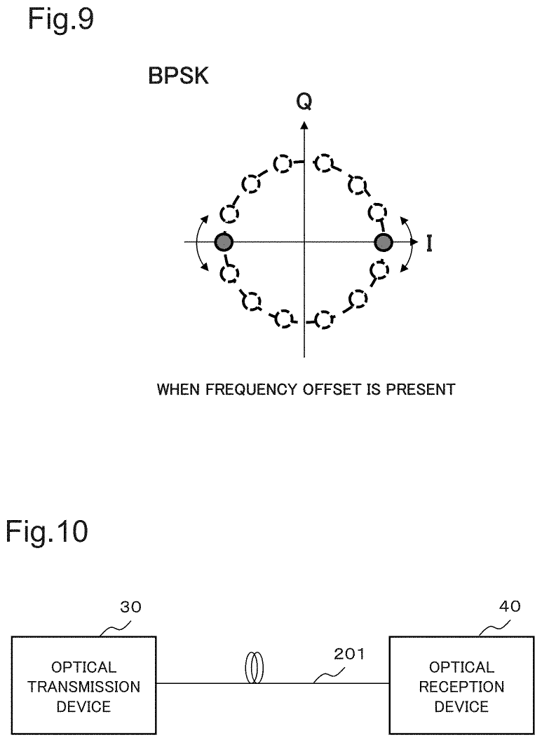

On the other hand, when a frequency offset is generated between a light source of an optical signal and a light source of local oscillation light, a constellation rotates as illustrated in FIG. 9. In the BPSK scheme illustrated in FIG. 8, only the I-axis component is given. However, not only the I-axis component but also the Q-axis component can have a value by intentionally generating a frequency offset. By giving the Q-axis component, an appropriate gain is set, and thus, noise in a signal is prevented from becoming too large and degradation in signal quality can be prevented.

In the optical communication system according to the present example embodiment, the frequency adjustment unit 15 in the optical transmission device 10 adjusts a frequency of light to be output from the light source unit 14, based on error information detected by the error detection unit 28 in the optical reception device 20. By adjusting the frequency in such a way as to decrease the number of errors, an appropriate offset may be added to a frequency of an optical signal transmitted from the optical transmission device 10 and a frequency of local oscillation light for use in detection of a reception signal performed by the optical reception device 20. Consequently, the optical communication system according to the present example embodiment can suppress influence of noise generated in a reception signal and can maintain reception quality.

### Third Example Embodiment

An optical communication system according to a third example embodiment of the present invention will be described. FIG. 10 illustrates an overview of a configuration of the optical communication system according to the present example embodiment. The optical communication system according to the present example embodiment includes an optical transmission device 30 and an optical reception device 40. The optical transmission device 30 and the optical reception device 40 are connected to each other via a communication channel 201.

The optical communication system according to the present example embodiment is a network system that performs optical communication of the digital coherent scheme via the communication channel 201 similarly to the second example embodiment. In the optical communication network according to the second example embodiment, offset quantity for a frequency of a light source of an optical transmission device is adjusted. On the contrary, an optical communication network according to the present example embodiment is characterized in that offset quantity for a frequency of local oscillation light of an optical reception device is adjusted.

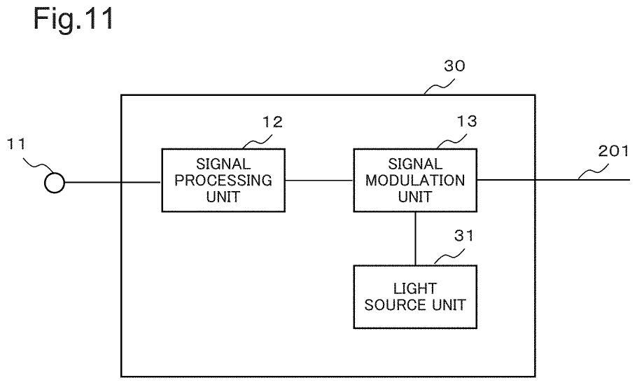

A configuration of the optical transmission device 30 will be described. FIG. 11 illustrates the configuration of the optical transmission device 30 according to the present example embodiment. The optical transmission device 30 includes a client signal input unit 11, a signal processing unit 12, a signal modulation unit 13, and a light source unit 31. Configurations and functions of the client signal input unit 11, the signal processing unit 12, and the signal modulation unit 13 according to the present example embodiment are similar to the units of the same names according to the second example embodiment.

The light source unit 31 has a function similar to the light source unit 14 according to the second example embodiment, except for a function of offsetting a frequency of light to be output. In other words, the light source unit 31 includes a semiconductor laser, and outputs continuous light of a predetermined frequency to the signal modulation unit 13. The predetermined frequency is allocated based on wavelength design of an optical communication network.

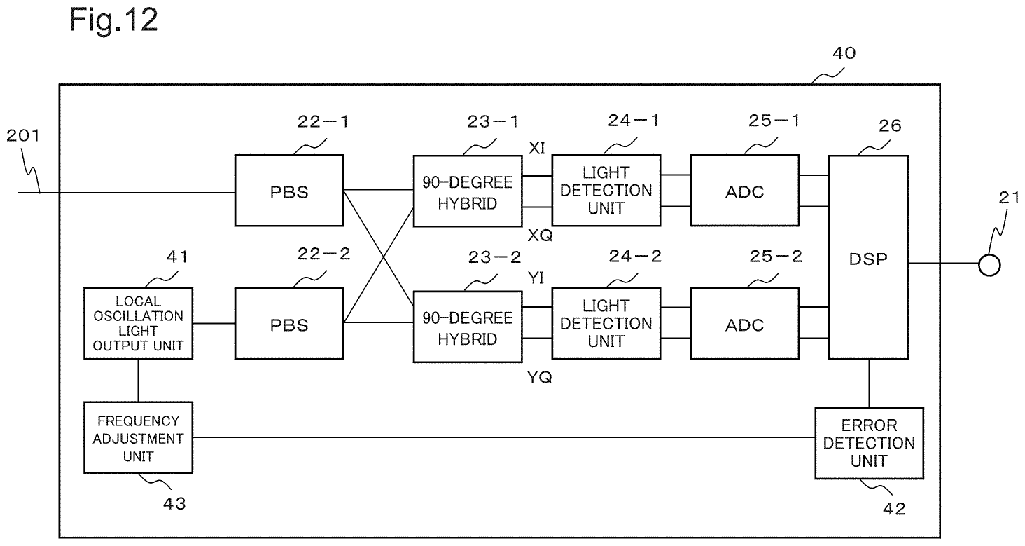

A configuration of the optical reception device 40 will be described. FIG. 12 illustrates the configuration of the optical reception device 40 according to the present example embodiment. The optical reception device 40 includes a client signal output unit 21, a PBS 22, a 90-degree hybrid 23, a light detection unit 24, an ADC 25, a DSP 26, a local oscillation light output unit 41, an error detection unit 42, and a frequency adjustment unit 43.

Configurations and functions of the client signal output unit 21, the PBS 22, the 90-degree hybrid 23, the light detection unit 24, the ADC 25, and the DSP 26 according to the present example embodiment are similar to the units of the same names according to the second example embodiment. In other words, as the PBS 22, a PBS 22-1 that polarization-separates an optical signal input via the communication channel 201 and a PBS 22-2 that polarization-separates local oscillation light are included. A 90-degree hybrid 23-1, a light detection unit 24-1, and an ADC 25-1 that process a signal of an X-polarized wave are included, and a 90-degree hybrid 23-2, a light detection unit 24-2, and an ADC 25-2 that process a signal of a Y-polarized wave are included.

The local oscillation light output unit 41 generates local oscillation light of a predetermined frequency combined with the optical signal transmitted via the communication channel 201 and for use in generating an optical signal of an intermediate frequency. The local oscillation light output unit 41 is configured by using a semiconductor laser. The predetermined frequency is set based on a frequency of the optical signal transmitted via the communication channel 201. The local oscillation light output unit 41 outputs light of a frequency with an offset added to the predetermined frequency. Frequency offset quantity is controlled by the frequency adjustment unit 43.

The error detection unit 42 has a function similar to the error detection unit 28 according to the second example embodiment. The error detection unit 42 according to the present example embodiment monitors signal reception processing performed by the DSP 26, and measures the number of errors, based on the number of error corrections. The error detection unit 42 sends, to the frequency adjustment unit 43 within an own device, error information calculated based on a result of measuring errors. The error detection unit 42 according to the present example embodiment sends, as the error information, a BER to the frequency adjustment unit 43. The error detection unit 42 may be integrated with the DSP 26 as a part of the DSP 26.

The frequency adjustment unit 43 controls offset quantity for a frequency of the local oscillation light output unit 41. The frequency adjustment unit 43 controls frequency offset quantity, based on the error information sent from the error detection unit 42. The frequency adjustment unit 43 controls the frequency offset quantity in such a way as to decrease the BER sent as the error information.

An operation of the optical communication system according to the present example embodiment will be described. The optical communication system according to the present example embodiment operates similarly to the optical communication system according to the second example embodiment, regarding an operation other than adjusting a frequency offset for the optical signal and the local oscillation light. In the optical communication system according to the present example embodiment, the frequency offset for the optical signal and the local oscillation light is adjusted based on a result of detection of the number of errors performed by the optical reception device 40. In other words, in the optical communication system according to the present example embodiment, the frequency adjustment unit 43 in the optical reception device 40 changes offset quantity from a set value for a frequency of the local oscillation light output from the local oscillation light output unit 41, and controls the frequency of the local oscillation light, based on offset quantity when the number of errors is minimum.

The optical communication system according to the present example embodiment has an advantageous effect similar to the optical communication system according to the second example embodiment. Since the frequency of the local oscillation light is adjusted on the optical reception device 40 side, based on the number of errors, it is unnecessary to send the number of errors to the optical transmission device 30, and thus, the configuration of the system can be further simplified.

### Fourth Example Embodiment

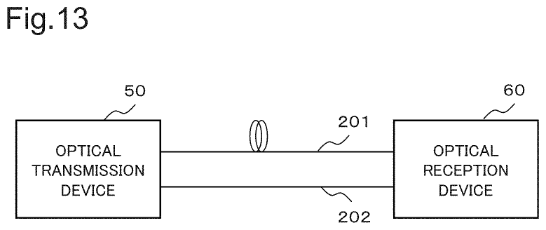

A fourth example embodiment of the present invention will be described in detail with reference to the drawings. FIG. 13 illustrates an overview of a configuration of an optical communication system according to the present example embodiment. The optical communication system according to the present example embodiment includes an optical transmission device 50 and an optical reception device 60. The optical transmission device 50 and the optical reception device 60 are connected via a communication channel 201 and a communication channel 202.

The optical communication system according to the present example embodiment is a network system that performs optical communication of the digital coherent scheme via the communication channel 201 similarly to the second example embodiment. In the optical communication system according to the second example embodiment, a frequency offset for an optical signal and local oscillation light is adjusted by adjusting the optical signal in such a way as to minimize the number of errors. The optical communication system according to the present example embodiment is characterized in that, instead of such a configuration, a frequency of an optical signal is monitored, and a frequency of light output from a light source unit is adjusted in such a way that a frequency offset for the optical signal and local oscillation light becomes a set value.

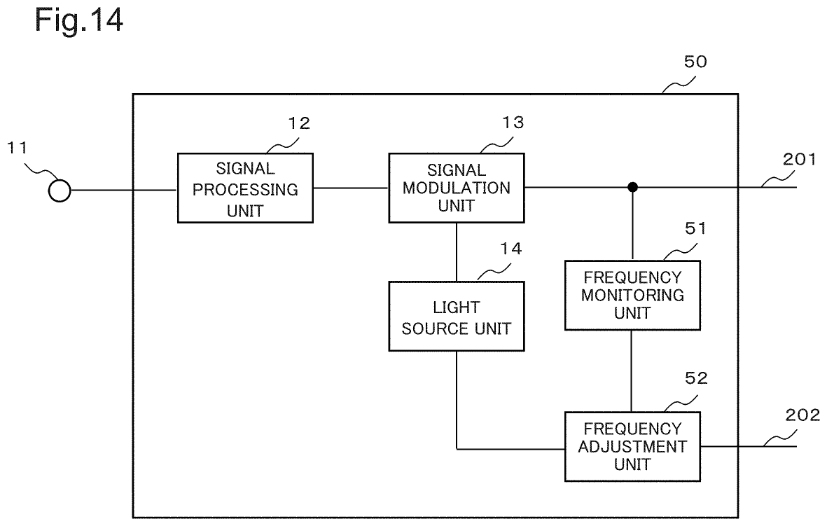

A configuration of the optical transmission device 50 will be described. FIG. 14 illustrates the configuration of the optical transmission device 50 according to the present example embodiment. The optical transmission device 50 includes a client signal input unit 11, a signal processing unit 12, a signal modulation unit 13, a light source unit 14, a frequency monitoring unit 51, and a frequency adjustment unit 52.

Configurations and functions of the client signal input unit 11, the signal processing unit 12, the signal modulation unit 13, and the light source unit 14 according to the present example embodiment are similar to the units of the same names according to the second example embodiment.

The frequency monitoring unit 51 has a function of measuring a frequency of an output signal of the signal modulation unit 13. To the frequency monitoring unit 51, for example, the output signal of the signal modulation unit 13 is input by being branched by an optical coupler. The frequency monitoring unit 51 sends, to the frequency adjustment unit 52, information on the frequency of the output signal of the signal modulation unit 13.

The frequency adjustment unit 52 controls, based on the frequency of the output signal sent from the frequency monitoring unit 51 and a frequency of local oscillation light sent from the optical reception device 60 via the communication channel 202, an offset value for a frequency of light output by the light source unit 14. The frequency adjustment unit 52 monitors a difference between the frequency of the output signal sent from the frequency monitoring unit 51 and the frequency of the local oscillation light sent from the optical reception device 60, that is, a frequency offset. The frequency adjustment unit 52 controls, based on a set value for a frequency offset set in such a way that the frequency offset does not become 0, offset quantity for the frequency of the light to be output by the light source unit 14.

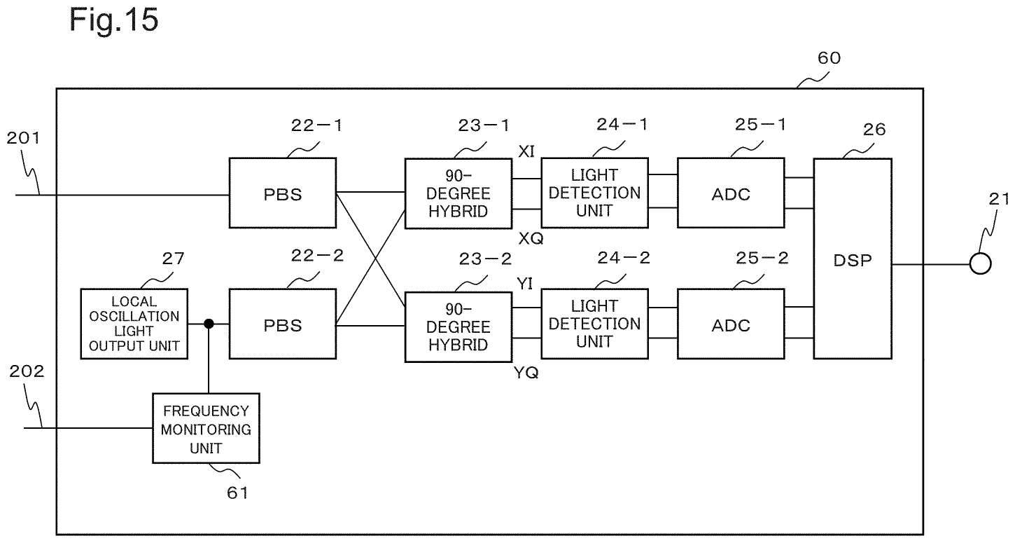

A configuration of the optical reception device 60 will be described. FIG. 15 illustrates the configuration of the optical reception device 60 according to the present example embodiment. The optical reception device 60 includes a client signal output unit 21, a PBS 22, a 90-degree hybrid 23, a light detection unit 24, an ADC 25, a DSP 26, a local oscillation light output unit 27, and a frequency monitoring unit 61.

Configurations and functions of the client signal output unit 21, the PBS 22, the 90-degree hybrid 23, the light detection unit 24, the ADC 25, the DSP 26, and the local oscillation light output unit 27 according to the present example embodiment are similar to the units of the same names according to the second example embodiment. In other words, as the PBS 22, a PBS 22-1 that polarization-separates an optical signal input via the communication channel 201 and a PBS 22-2 that polarization-separates local oscillation light are included. A 90-degree hybrid 23-1, a light detection unit 24-1, and an ADC 25-1 that process an X-polarized wave are included, and a 90-degree hybrid 23-2, a light detection unit 24-2, and an ADC 25-2 that process a Y-polarized wave are included.

The frequency monitoring unit 61 has a function of measuring a frequency of output light of the local oscillation light output unit 27. To the frequency monitoring unit 61, the output light of the local oscillation light output unit 27 is input by being branched by, for example, an optical coupler. The frequency monitoring unit 61 sends, to the frequency adjustment unit 52 in the optical transmission device 50 via the communication channel 202, information on the frequency of the output light of the local oscillation light output unit 27.

An operation of the optical communication system according to the present example embodiment will be described. The optical communication system according to the present example embodiment operates similarly to the optical communication system according to the second example embodiment, regarding an operation other than adjusting a frequency offset for the optical signal and the local oscillation light.

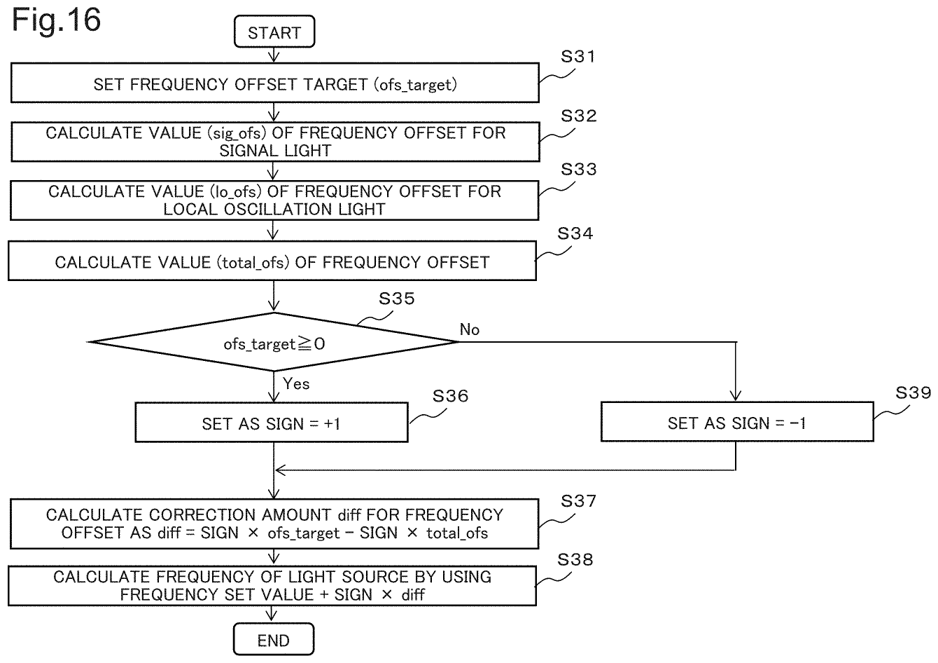

An operation of adjusting, by the optical transmission device 50 according to the present example embodiment, a frequency to be output by the light source unit 14 will be described. FIG. 16 illustrates operation flow of adjusting a frequency of light to be output by the light source unit 14.

First, the frequency adjustment unit 52 sets a frequency offset target ofs_target (Step S31). The frequency offset target ofs_target indicates a target of a difference between a frequency of light output by the light source unit 14 and a frequency of light output by the local oscillation light output unit 41. The frequency offset target ofs_target is preliminarily stored in the frequency adjustment unit 52. A set value of the frequency offset target ofs_target may be input by an operator or the like.

When the frequency offset target ofs_target is set, the frequency adjustment unit 52 calculates a frequency offset sig_ofs for an optical signal, that is, a difference between a frequency of an actually output optical signal and a frequency set value for an optical signal (Step S32). The frequency adjustment unit 52 calculates the frequency offset sig_ofs for the optical signal, based on a result of monitoring a frequency of an optical signal sent from the frequency monitoring unit 51. The frequency adjustment unit 52 calculates the frequency offset for the optical signal as a frequency offset sig_ofs=a monitored value of a frequency of an optical signal−a frequency set value for an optical signal.

When the frequency offset for the optical signal is calculated, the frequency adjustment unit 52 calculates a frequency offset lo_ofs for local oscillation light, that is, a difference between a frequency of local oscillation light actually output by the optical reception device 60 and a frequency set value for local oscillation light (Step S33). The frequency adjustment unit 52 calculates the frequency offset lo_ofs for the local oscillation light, based on a result of monitoring a frequency of local oscillation light sent from the frequency monitoring unit 61 via the communication channel 202. The frequency adjustment unit 52 calculates the frequency offset for the local oscillation light as a frequency offset lo_ofs=a result of monitoring a frequency of local oscillation light−a frequency set value for local oscillation light.

When the frequency offsets for the optical signal and the local oscillation light are calculated, the frequency adjustment unit 52 calculates a frequency offset total_ofs for the optical signal and the local oscillation light (Step S34). The frequency adjustment unit 52 calculates the frequency offset for the optical signal and the local oscillation light by using a frequency offset total_ofs=the frequency offset sig_ofs for the optical signal−the frequency offset lo_ofs for the local oscillation light.

When a difference in the frequencies of the optical signal and the local oscillation light, that is, the frequency offset is calculated, the frequency adjustment unit 52 checks positive/negative of the frequency offset target ofs_target, and determines a coefficient SIGN for use in calculating a correction amount diff for a frequency of light output by the light source unit 14.

When a value of the frequency offset target ofs_target is equal to or more than 0 (Yes in Step S35), the frequency adjustment unit 52 sets the coefficient SIGN as +1 (Step S36). When a value of the frequency offset target ofs_target is smaller than 0 (No in Step S35), the frequency adjustment unit 52 sets the coefficient SIGN as −1 (Step S39).

When the coefficient SIGN for use in calculating the correction amount diff for the frequency of the light output by the light source unit 14 is determined, the frequency adjustment unit 52 calculates a correction amount diff for the frequency offset (Step S37). The frequency adjustment unit 52 calculates the correction amount diff as diff=SIGN×ofs_target−SIGN×total_ofs.

When the correction amount diff for the frequency is calculated, the frequency adjustment unit 52 calculates a frequency of the light to be output by the light source unit 14 as a frequency set value+SIGN×diff (Step S37). When the frequency of the light to be output by the light source unit 14 is calculated, the frequency adjustment unit 52 controls the light source unit 14 in such a way that light of the calculated frequency is output.

In the optical communication system according to the present example embodiment, the frequencies of the optical signal and the local oscillation light are monitored, and the frequency adjustment unit 52 controls the frequency of the light to be output from the light source unit 14, in such a way that the frequency offset being a difference in the frequencies of the optical signal and the local oscillation light becomes a set value. By keeping the frequencies of the optical signal and the local oscillation light at a set value other than 0 and giving the frequency offset between the optical signal and the local oscillation light in such a way, noise generated in a Q-ch signal can be prevented. Consequently, the optical communication system according to the present example embodiment can suppress influence of noise generated in a reception signal and can maintain reception quality.

### Fifth Example Embodiment

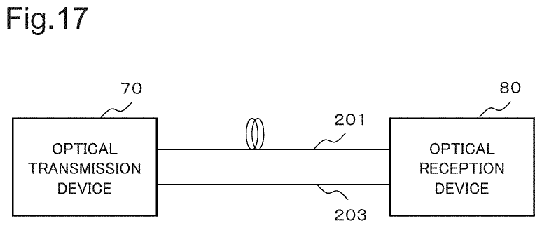

A fifth example embodiment of the present invention will be described in detail with reference to the drawings. FIG. 17 illustrates an overview of a configuration of an optical communication system according to the present example embodiment. The optical communication system according to the present example embodiment includes an optical transmission device 70 and an optical reception device 80. The optical transmission device 70 and the optical reception device 80 are connected via a communication channel 201 and a communication channel 203. The communication channel 203 is a communication network through which a control signal and the like is sent from the optical transmission device 70 to the optical reception device 80.

The optical communication system according to the present example embodiment is a network system that performs optical communication of the digital coherent scheme via the communication channel 201 similarly to the second example embodiment. The optical communication system according to the present example embodiment is characterized in that a frequency of local oscillation light of the optical reception device 80 is controlled, based on a result of measuring frequencies of an optical signal and local oscillation light, in such a way that a frequency offset for the optical signal and the local oscillation light becomes a set value.

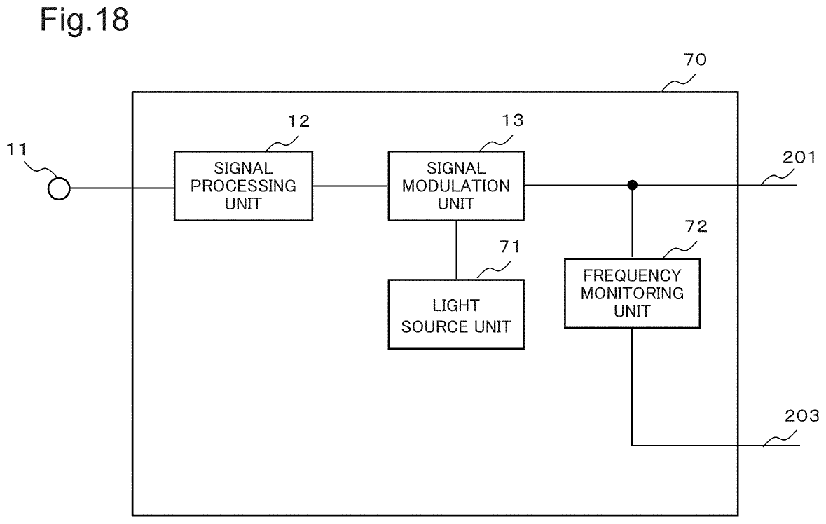

A configuration of the optical transmission device 70 will be described. FIG. 18 illustrates the configuration of the optical transmission device 70 according to the present example embodiment. The optical transmission device 70 includes a client signal input unit 11, a signal processing unit 12, a signal modulation unit 13, a light source unit 71, and a frequency monitoring unit 72. Configurations and functions of the client signal input unit 11, the signal processing unit 12, and the signal modulation unit 13 according to the present example embodiment are similar to the units of the same names according to the second example embodiment.

The light source unit 71 has a function similar to the light source unit 14 according to the second example embodiment, except for a function of offsetting a frequency of light to be output. In other words, the light source unit 71 includes a semiconductor laser, and outputs continuous light of a predetermined frequency to the signal modulation unit 13. The predetermined frequency is allocated based on wavelength design of an optical communication network.

The frequency monitoring unit 72 has a function of measuring a frequency of an output signal of the signal processing unit 12. To the frequency monitoring unit 72, for example, an output signal of the signal modulation unit 13 is input by being branched by an optical coupler. The frequency monitoring unit 72 sends, to a frequency adjustment unit 82 in the optical reception device 80 via the communication channel 203, information on the frequency of the output signal of the signal modulation unit 13.

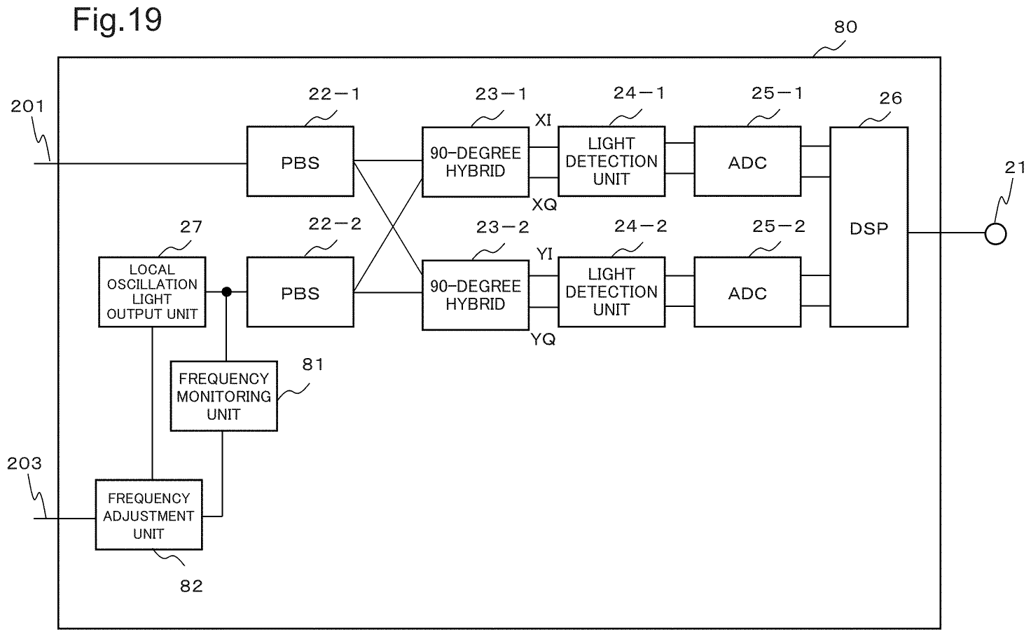

A configuration of the optical reception device 80 will be described. FIG. 19 illustrates the configuration of the optical reception device 80 according to the present example embodiment. The optical reception device 80 includes a client signal output unit 21, a PBS 22, a 90-degree hybrid 23, a light detection unit 24, an ADC 25, a DSP 26, a local oscillation light output unit 27, a frequency monitoring unit 81, and the frequency adjustment unit 82.

Configurations and functions of the client signal output unit 21, the PBS 22, the 90-degree hybrid 23, the light detection unit 24, the ADC 25, and the DSP 26 according to the present example embodiment are similar to the units of the same names according to the second example embodiment. In other words, as the PBS 22, a PBS 22-1 that polarization-separates an optical signal input via the communication channel 201 and a PBS 22-2 that polarization-separates local oscillation light are included. A 90-degree hybrid 23-1, a light detection unit 24-1, and an ADC 25-1 that process a signal of an X-polarized wave are included, and a 90-degree hybrid 23-2, a light detection unit 24-2, and an ADC 25-2 that process a signal of a Y-polarized wave are included.

The frequency monitoring unit 81 has a function of measuring a frequency of output light of the local oscillation light output unit 27. To the frequency monitoring unit 81, the output light of the local oscillation light output unit 27 is input by being branched by, for example, an optical coupler. The frequency monitoring unit 81 sends, to the frequency adjustment unit 82 of an own device, information on the frequency of the output light of the local oscillation light output unit 27.

The frequency adjustment unit 82 controls, based on a frequency of an output signal sent from the frequency monitoring unit 72 in the optical transmission device 70 via the communication channel 203 and a frequency of local oscillation light sent from the frequency monitoring unit 81 of the own device, offset quantity for the frequency of the light output by the local oscillation light output unit 27. The frequency adjustment unit 82 monitors a frequency of an optical signal sent from the optical transmission device 70 and the frequency of the local oscillation light, and controls, based on a set value for a frequency offset set in such a way that a total offset does not become 0, the offset quantity for the frequency of the local oscillation light output by the local oscillation light output unit 27.

An operation of the optical communication system according to the present example embodiment will be described. The optical communication system according to the present example embodiment operates similarly to the fourth example embodiment, except for adjusting a frequency offset by controlling the frequency of the local oscillation light on an optical reception device side. In the optical communication system according to the present example embodiment, the frequency adjustment unit 82 in the optical reception device 80 calculates a difference in frequencies, based on the frequency of the optical signal sent from the optical transmission device 70 and the frequency of the local oscillation light measured by the own device. The frequency adjustment unit 82 adjusts the frequency of the local oscillation light, based on the difference in the frequencies of the optical signal and the local oscillation light and a set value for a frequency offset. The frequency adjustment unit 82 adjusts the frequency of the local oscillation light to be output from the local oscillation light output unit 27, in such a way that the calculated difference in the frequencies of the optical signal and the local oscillation light is consistent with the set value for the frequency offset.

The optical communication system according to the present example embodiment has an advantageous effect similar to the optical communication system according to the fourth example embodiment. In other words, in the optical communication system according to the present example embodiment, the frequencies of the optical signal and the local oscillation light are monitored, and the frequency adjustment unit 82 controls the frequency of the light to be output from the local oscillation light output unit 27, in such a way that the frequency offset being a difference in the frequencies of the optical signal and the local oscillation light becomes a set value. By keeping the frequencies of the optical signal and the local oscillation light at a set value other than 0 and giving the frequency offset between the optical signal and the local oscillation light in such a way, noise generated in a Q-ch signal can be prevented. Consequently, the optical communication system according to the present example embodiment can suppress influence of noise generated in a reception signal and can maintain reception quality.

### Sixth Example Embodiment

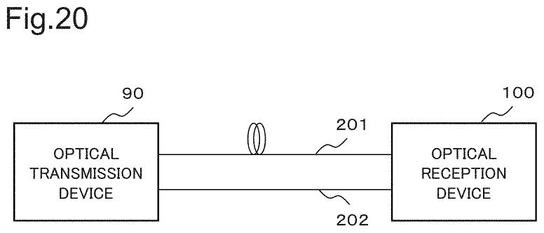

A sixth example embodiment of the present invention will be described in detail with reference to the drawings. FIG. 20 illustrates an overview of a configuration of an optical communication system according to the present example embodiment. The optical communication system according to the present example embodiment includes an optical transmission device 90 and an optical reception device 100. The optical transmission device 90 and the optical reception device 100 are connected via a communication channel 201 and a communication channel 202.

The optical communication system according to the present example embodiment is a network system that performs optical communication of the digital coherent scheme via the communication channel 201 similarly to the second example embodiment. In the optical communication system according to the fourth and fifth example embodiments, a frequency difference is calculated by measuring frequencies of an optical signal and local oscillation light. On the contrary, the optical communication system according to the present example embodiment is characterized in that information on the frequency difference between an optical signal and local oscillation light is acquired by monitoring signal processing of an optical reception device.

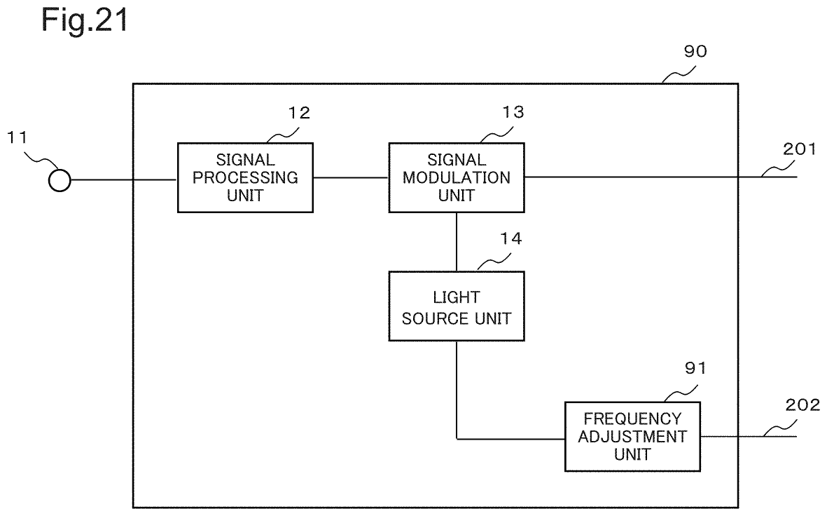

A configuration of the optical transmission device 90 will be described. FIG. 21 illustrates the configuration of the optical transmission device 90 according to the present example embodiment. The optical transmission device 90 includes a client signal input unit 11, a signal processing unit 12, a signal modulation unit 13, a light source unit 14, and a frequency adjustment unit 91.

Configurations and functions of the client signal input unit 11, the signal processing unit 12, the signal modulation unit 13, and the light source unit 14 according to the present example embodiment are similar to the units of the same names according to the second example embodiment.

The frequency adjustment unit 91 controls, based on offset quantity for a frequency of an optical signal transmitted by the optical transmission device 90 sent from a frequency offset detection unit 101 in the optical reception device 100 via the communication channel 202 and a frequency of local oscillation light of the optical reception device 100, offset quantity for a frequency of light output by the light source unit 14. The frequency adjustment unit 91 controls, based on offset quantity for the frequencies of the optical signal and the local oscillation light sent from the optical reception device 100, the offset quantity for the frequency of the light source unit 14 in such a way that a total offset does not become 0.

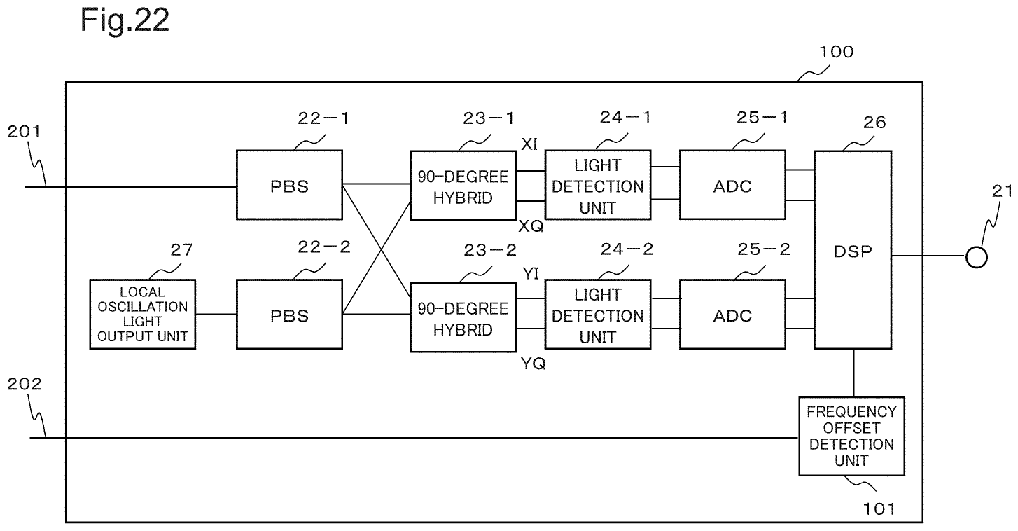

A configuration of the optical reception device 100 will be described. FIG. 22 illustrates the configuration of the optical reception device 100 according to the present example embodiment. The optical reception device 100 includes a client signal output unit 21, a PBS 22, a 90-degree hybrid 23, a light detection unit 24, an ADC 25, a DSP 26, a local oscillation light output unit 27, and the frequency offset detection unit 101.

Configurations and functions of the client signal output unit 21, the PBS 22, the 90-degree hybrid 23, the light detection unit 24, the ADC 25, the DSP 26, and the local oscillation light output unit 27 according to the present example embodiment are similar to the units of the same names according to the second example embodiment. In other words, as the PBS 22, a PBS 22-1 that polarization-separates an optical signal input via the communication channel 201 and a PBS 22-2 that polarization-separates local oscillation light are included. A 90-degree hybrid 23-1, a light detection unit 24-1, and an ADC 25-1 that process a signal of an X-polarized wave are included, and a 90-degree hybrid 23-2, a light detection unit 24-2, and an ADC 25-2 that process a signal of a Y-polarized wave are included.

The frequency offset detection unit 101 monitors reception processing performed by the DSP 26, and detects, as a frequency offset, a difference between a frequency of an optical signal transmitted by the optical transmission device 90 and a frequency of local oscillation light output by the local oscillation light output unit 27. The frequency offset detection unit 101 sends, to the frequency adjustment unit 91 in the optical transmission device 90 via the communication channel 202, information on the frequency offset indicating the detected difference in the frequencies of the optical signal and the local oscillation light. The frequency offset detection unit 101 may be integrated with the DSP 26 as a part of the DSP 26.

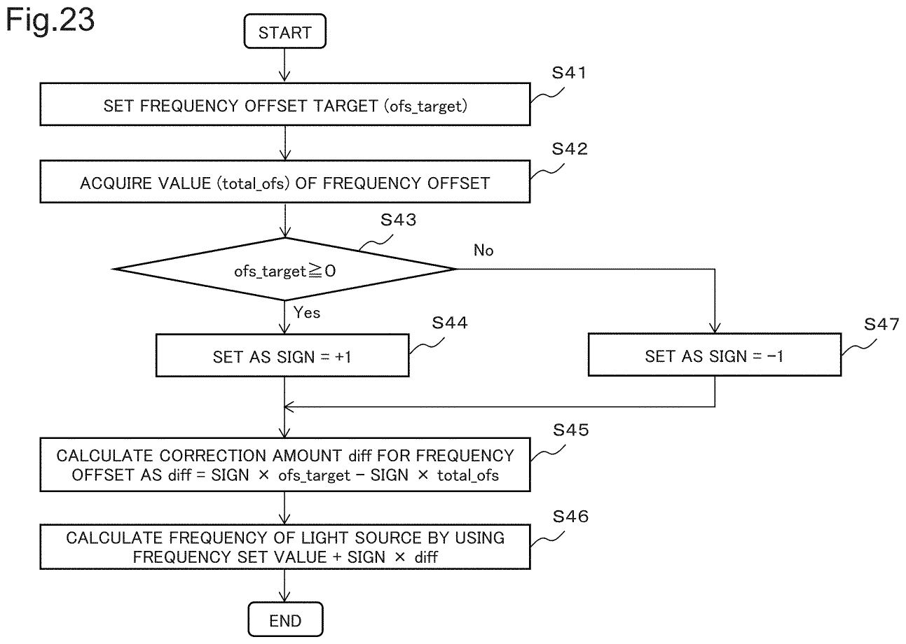

An operation of the optical communication system according to the present example embodiment will be described. The optical communication system according to the present example embodiment operates similarly to the optical communication system according to the second example embodiment, regarding an operation other than adjusting a frequency offset for an optical signal and local oscillation light. An operation of adjusting, by the optical transmission device 90 according to the present example embodiment, a frequency output by the light source unit 14 will be described. FIG. 23 illustrates operation flow of adjusting a frequency of light output by the light source unit 14.

First, the frequency adjustment unit 91 sets a frequency offset target ofs_target (Step S41). The frequency offset target ofs_target indicates a target of a difference between a frequency of light output by the light source unit 14 and a frequency of light output by the local oscillation light output unit 27. The frequency offset target ofs_target may be preliminarily stored in the frequency adjustment unit 91, or a set value may be input by an operator or the like.

When the frequency offset target ofs_target is set, the frequency adjustment unit 91 acquires data on a frequency offset total_ofs for an optical signal and local oscillation light (Step S42). The data on the frequency offset total_ofs for the optical signal and the local oscillation light are received from the frequency offset detection unit 101 in the optical reception device 100 via the communication channel 202.

Upon reception of the data on the frequency offset for the optical signal and the local oscillation light, the frequency adjustment unit 91 checks positive/negative of the frequency offset target ofs_target, and determines a coefficient SIGN for use in calculating a correction amount diff for the frequency offset.

When a value of the frequency offset target ofs_target is equal to or more than 0 (Yes in Step S43), the frequency adjustment unit 91 sets the coefficient SIGN as +1 (Step S44). When the value of the frequency offset target ofs_target is smaller than 0 (No in Step S43), the frequency adjustment unit 91 sets the coefficient SIGN as −1 (Step S47).

When the coefficient SIGN for use in calculating the correction amount diff is determined, the frequency adjustment unit 91 calculates a correction amount diff for the frequency offset (Step S45). The frequency adjustment unit 91 calculates the correction amount diff as diff=SIGN×ofs_target−SIGN×total_ofs.

When the correction amount diff for the frequency is calculated, the frequency adjustment unit 91 calculates a frequency of the light to be output by the light source unit 14 as a frequency set value+SIGN×diff (Step S46). When the frequency of the light to be output by the light source unit 14 is calculated, the frequency adjustment unit 91 controls the light source unit 14 in such a way that light of the calculated frequency is output.

In the optical communication system according to the present example embodiment, frequencies of an optical signal and local oscillation light are acquired from the frequency offset detection unit 101, and the frequency of the light to be output from the light source unit 14 is controlled in such a way that the frequency offset indicating a difference in the frequencies of the optical signal and the local oscillation light becomes a set value. By keeping the frequencies of the optical signal and the local oscillation light at a set value other than 0 and giving the frequency offset between the optical signal and the local oscillation light in such a way, noise generated in a Q-ch signal can be prevented. Consequently, the optical communication system according to the present example embodiment can suppress influence of noise generated in a reception signal and can maintain reception quality.

### Seventh Example Embodiment

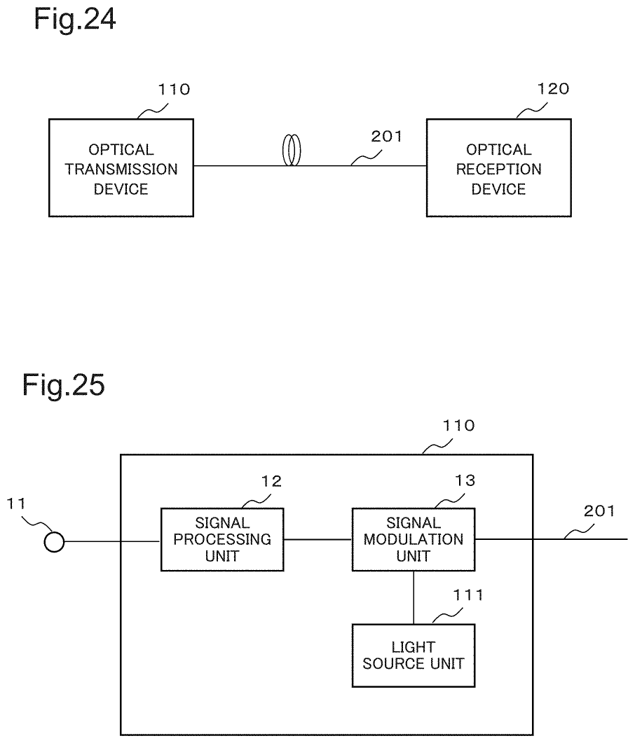

A seventh example embodiment of the present invention will be described in detail with reference to the drawings. FIG. 24 illustrates an overview of a configuration of an optical communication system according to the present example embodiment. The optical communication system according to the present example embodiment includes an optical transmission device 110 and an optical reception device 120. The optical transmission device 110 and the optical reception device 120 are connected via a communication channel 201.

The optical communication system according to the present example embodiment is a network system that performs optical communication of the digital coherent scheme via the communication channel 201 similarly to the second example embodiment. In the optical communication system according to the sixth example embodiment, processing on a reception signal performed by the DSP 26 is monitored by the frequency offset detection unit 101, information on a difference in frequencies of an optical signal and local oscillation light is acquired, and the frequency of the optical signal is adjusted in an optical transmission device. The optical communication system according to the present example embodiment is characterized in that processing on a reception signal performed by a DSP 26 is monitored by a frequency offset detection unit 101, and a frequency offset for an optical signal and local oscillation light is adjusted by adjusting a frequency of the local oscillation light.

A configuration of the optical transmission device 110 will be described. FIG. 25 illustrates the configuration of the optical transmission device 110 according to the present example embodiment. The optical transmission device 110 includes a client signal input unit 11, a signal processing unit 12, a signal modulation unit 13, and a light source unit 111. Configurations and functions of the client signal input unit 11, the signal processing unit 12, and the signal modulation unit 13 according to the present example embodiment are similar to the units of the same names according to the second example embodiment.

The light source unit 111 has a function similar to the light source unit 14 according to the second example embodiment, except for a function of offsetting a frequency of light to be output. In other words, the light source unit 111 includes a semiconductor laser, and outputs continuous light of a predetermined frequency to the signal modulation unit 13. The predetermined frequency is allocated based on wavelength design of an optical communication network.

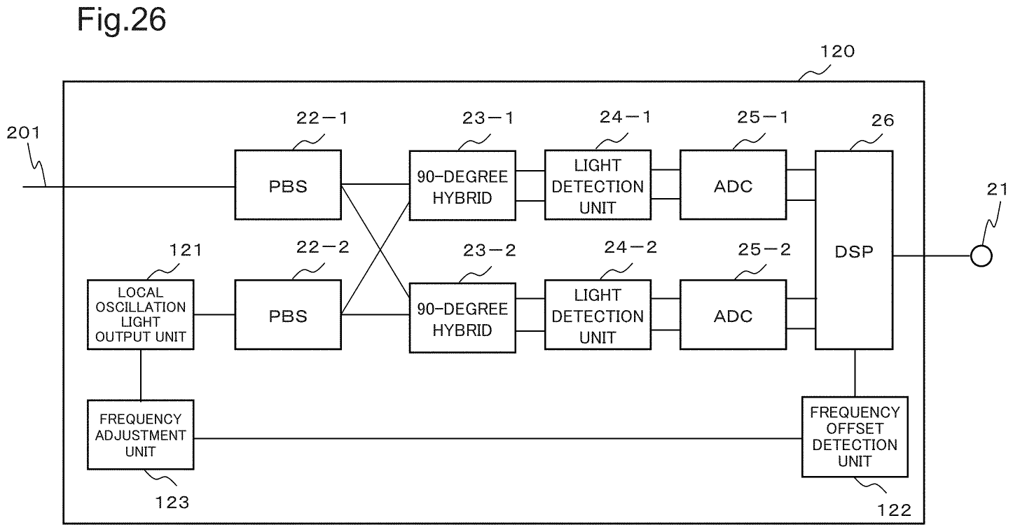

A configuration of the optical reception device 120 will be described. FIG. 26 illustrates the configuration of the optical reception device 120 according to the present example embodiment. The optical reception device 120 includes a client signal output unit 21, a PBS 22, a 90-degree hybrid 23, a light detection unit 24, an ADC 25, the DSP 26, a local oscillation light output unit 121, a frequency offset detection unit 122, and a frequency adjustment unit 123.

Configurations and functions of the client signal output unit 21, the PBS 22, the 90-degree hybrid 23, the light detection unit 24, the ADC 25, and the DSP 26 according to the present example embodiment are similar to the units of the same names according to the second example embodiment. In other words, as the PBS 22, a PBS 22-1 that polarization-separates an optical signal input via the communication channel 201 and a PBS 22-2 that polarization-separates local oscillation light are included. A 90-degree hybrid 23-1, a light detection unit 24-1, and an ADC 25-1 that process a signal of an X-polarized wave are included, and a 90-degree hybrid 23-2, a light detection unit 24-2, and an ADC 25-2 that process a signal of a Y-polarized wave are included.

The local oscillation light output unit 121 generates local oscillation light of a predetermined frequency combined with an optical signal transmitted via the communication channel 201 and for use in generating an optical signal of an intermediate frequency. The local oscillation light output unit 121 includes a semiconductor laser, and outputs light of a frequency set based on a frequency of the optical signal transmitted via the communication channel 201. The local oscillation light output unit 121 outputs light with a frequency offset from a predetermined frequency as a center frequency. The frequency offset is controlled by the frequency adjustment unit 123.

The frequency offset detection unit 122 monitors reception processing performed by the DSP 26, and detects as offset quantity for a frequency of an optical signal transmitted by the optical transmission device 110 and a frequency of local oscillation light output by the local oscillation light output unit 121. The frequency offset detection unit 122 sends information on the offset quantity for the frequencies to the frequency adjustment unit 123 of an own device. The frequency offset detection unit 122 may be integrated with the DSP 26 as a part of the DSP 26.

The frequency adjustment unit 123 controls offset quantity for the frequency of the local oscillation light output by the local oscillation light output unit 121. The frequency adjustment unit 123 controls, based on the information on the frequency offset for the optical signal and the local oscillation light sent from the frequency offset detection unit 122, the offset quantity for the frequency of the local oscillation light output by the local oscillation light output unit 121.

The optical communication system according to the present example embodiment operates similarly to the sixth example embodiment, except for adjusting a frequency offset by controlling the frequency of the local oscillation light on an optical reception device side. In the optical communication system according to the present example embodiment, the frequency adjustment unit 123 in the optical reception device 120 acquires the information on the difference in the frequencies of the optical signal and the local oscillation light detected by the frequency offset detection unit 122. The frequency adjustment unit 123 adjusts the frequency of the local oscillation light, based on a set value for the frequency offset indicating the difference between the frequency of the optical signal and the frequency of the local oscillation light. The frequency adjustment unit 123 adjusts the frequency of the local oscillation light to be output from the local oscillation light output unit 121, in such a way that the calculated difference in the frequencies of the optical signal and the local oscillation light is consistent with the set value for the frequency offset.

In the optical communication system according to the present example embodiment, the frequencies of the optical signal and the local oscillation light are acquired from the frequency offset detection unit 122, and a frequency of light to be output from the local oscillation light output unit 121 is controlled in such a way that the frequency offset indicating the difference in the frequencies of the optical signal and the local oscillation light becomes a set value. By keeping the frequencies of the optical signal and the local oscillation light at a set value other than 0 and giving the frequency offset between the optical signal and the local oscillation light in such a way, the optical communication system according to the present example embodiment can prevent noise generated in a Q-ch signal. Consequently, the optical communication system according to the present example embodiment can suppress influence of noise generated in a reception signal and can maintain reception quality.

The optical communication system according to the second to seventh example embodiments indicates a configuration of performing unidirectional communication in which an optical signal is transmitted from an optical transmission device to an optical reception device. Instead of such a configuration, the optical communication system according to the example embodiments may perform bidirectional optical communication. When bidirectional optical communication is performed, control of the frequency offset being the difference in frequencies of an optical signal and local oscillation light is performed on both directions. When bidirectional communication is performed, the optical communication system according to the example embodiments may be configured to transmit information such as error information, information on a frequency of light, and information on a frequency difference between an optical signal and local oscillation light, by adding the information into a frame to be sent to an opposite device.

The whole or part of the example embodiments disclosed above can be described as, but not limited to, the following supplementary notes.

[Supplementary Note 1]

An optical transmission device including:

light output means for outputting light of a frequency allocated to the optical transmission device;

light modulation means for separating light output by the light output means into mutually orthogonal polarized waves, modulating an in-phase component and a quadrature component in each of the polarized waves, and outputting an optical signal acquired by polarization synthesis of modulated component waves;

reception information acquisition means for acquiring information on a reception state of the optical signal in an optical reception device being a transmission destination of the optical signal; and

frequency adjustment means for controlling, based on the information on the reception state, a frequency of light to be output by the light output means, and adjusting a frequency offset being a difference between a frequency of light output by the light output means and a frequency of local oscillation light for use in coherent detection of the optical signal by the optical reception device.

[Supplementary Note 2]

The optical transmission device according to supplementary note 1, wherein

the reception information acquisition means acquires, as the information on the reception state, information on a number of errors in the optical signal, and

the frequency adjustment means controls the frequency of the light to be output by the light output means, in such a way as to minimize the number of errors.

[Supplementary Note 3]

The optical transmission device according to supplementary note 1, further including

frequency measurement means for measuring a frequency of the optical signal output from the light modulation means, wherein

the reception information acquisition means acquires information on the frequency of the local oscillation light from the optical reception device, and

the frequency adjustment means controls, based on the frequency of the optical signal measured by the frequency measurement means and the frequency of the local oscillation light acquired by the reception information acquisition means, the frequency of the light to be output by the light output means, in such a way that the frequency offset becomes a preliminarily set value.

[Supplementary Note 4]

The optical transmission device according to supplementary note 1, wherein

the reception information acquisition means acquires information indicating a difference between the frequency of the optical signal and the frequency of the local oscillation light being received from the optical reception device, and

the frequency adjustment means controls, based on the difference, acquired by the reception information acquisition means, between the frequency of the optical signal and the frequency of the local oscillation light being received from the optical reception device, the frequency of the light to be output by the light output means, in such a way that the frequency offset becomes a preliminarily set value.

[Supplementary Note 5]

An optical reception device including:

local oscillation light output means for outputting local oscillation light of a frequency being set based on a frequency of an optical signal acquired by modulating, by an optical transmission device, an in-phase component and a quadrature component in each of orthogonal polarized waves;

optical signal reception means for combining the optical signal with the local oscillation light, and converting the combined signal into an electrical signal;

demodulation means for performing demodulation processing, based on the electrical signal converted by the optical signal reception means; and

local oscillation light adjustment means for controlling, based on information on a reception state of the optical signal, a frequency of light to be output by the local oscillation light output means, and adjusting a frequency offset being a difference between the frequency of the optical signal and the frequency of the local oscillation light output by the local oscillation light output means.

[Supplementary Note 6]

The optical reception device according to supplementary note 5, wherein

the local oscillation light adjustment means controls the frequency of the local oscillation light to be output by the local oscillation light output means, in such a way as to minimize a number of errors detected by the demodulation means.

[Supplementary Note 7]

The optical reception device according to supplementary note 5, further including:

local oscillation light measurement means for measuring the frequency of the local oscillation light output from the local oscillation light output means; and

transmission information acquisition means for acquiring information on the frequency of the optical signal from the optical transmission device, wherein

the local oscillation light adjustment means controls, based on the frequency of the local oscillation light measured by the local oscillation light measurement means and the frequency of the optical signal acquired by the transmission information acquisition means, the frequency of the local oscillation light to be output by the local oscillation light output means, in such a way that the frequency offset becomes a preliminarily set value.

[Supplementary Note 8]

The optical reception device according to supplementary note 5, wherein

the local oscillation light adjustment means controls, based on a difference between the frequency of the optical signal detected by the demodulation means and the frequency of the local oscillation light, the frequency of the light to be output by the local oscillation light output means, in such a way that the frequency offset becomes a preliminarily set value.

[Supplementary Note 9]

An optical communication system including:

the optical transmission device according to any one of supplementary notes 1 to 4; and

the optical reception device according to supplementary note 5, wherein

the frequency adjustment means of the optical transmission device adjusts, based on information on a reception state of the optical signal acquired from the optical reception device, a frequency offset being a difference from a frequency of light output by the light output means.

[Supplementary Note 10]

An optical communication method including:

outputting light of a frequency allocated to an own device;

separating the output light into mutually orthogonal polarized waves, modulating an in-phase component and a quadrature component in each of the polarized waves, and outputting an optical signal acquired by polarization synthesis of modulated component waves;

acquiring information on a reception state of the optical signal in an optical reception device being a transmission destination of the optical signal; and

controlling, based on the information on the reception state, a frequency of the light to be output, and adjusting a frequency offset being a difference between the frequency of the light output and a frequency of local oscillation light for use in coherent detection of the optical signal by the optical reception device.

[Supplementary Note 11]

The optical communication method according to supplementary note 10, wherein:

when acquiring the information on the reception state, acquiring, as the information on the reception state, information on a number of errors in the optical signal; and

when controlling the frequency of the light to be output, controlling the frequency of the light to be output, in such a way as to minimize the number of errors.

[Supplementary Note 12]

The optical communication method according to supplementary note 10, further including:

measuring a frequency of the output optical signal, wherein:

when acquiring the information on the reception state, acquiring information on the frequency of the local oscillation light from the optical reception device; and

when controlling the frequency of the light to be output, controlling, based on the measured frequency of the optical signal and the acquired frequency of the local oscillation light, the frequency of the light to be output, in such a way that the frequency offset becomes a preliminarily set value.

[Supplementary Note 13]

The optical communication method according to supplementary note 10, wherein:

when acquiring the information on the reception state, acquiring information indicating a difference between the frequency of the optical signal and the frequency of the local oscillation light being received from the optical reception device; and

when controlling the frequency of the light to be output, controlling, based on the acquired difference between the frequency of the optical signal and the frequency of the local oscillation light being received from the optical reception device, the frequency of the light to be output, in such a way that the frequency offset becomes a preliminarily set value.

[Supplementary Note 14]

The optical communication method according to any one of supplementary notes 10 to 13, further including:

outputting the local oscillation light of a frequency being set based on a frequency of an optical signal acquired by modulating, by an optical transmission device, an in-phase component and a quadrature component in each of orthogonal polarized waves;

combining the received optical signal with the local oscillation light, and converting the combined signal into an electrical signal;

performing demodulation processing, based on the converted electrical signal;

controlling, based on information on a reception state of the optical signal, the frequency of the local oscillation light to be output; and

adjusting a frequency offset being a difference between the frequency of the optical signal and the frequency of the local oscillation light.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-20995, filed on Feb. 8, 2018, the disclosure of which is incorporated herein in its entirety by reference.

### REFERENCE SIGNS LIST

1 Light output means
2 Light modulation means
3 Reception information acquisition means
4 Frequency adjustment means
10 Optical transmission device
11 Client signal input unit
12 Signal processing unit
13 Signal modulation unit
14 Light source unit
15 Frequency adjustment unit
20 Optical reception device
21 Client signal output unit
22 PBS
23 90-degree hybrid
24 Light detection unit
25 ADC
26 DSP
27 Local oscillation light output unit
28 Error detection unit
30 Optical transmission device
31 Light source unit
40 Optical reception device
41 Local oscillation light output unit
42 Error detection unit
43 Frequency adjustment unit
50 Optical transmission device
51 Frequency monitoring unit
52 Frequency adjustment unit
60 Optical reception device
61 Frequency monitoring unit
70 Optical transmission device
71 Light source unit
72 Frequency monitoring unit
80 Optical reception device
81 Frequency monitoring unit
82 Frequency adjustment unit
90 Optical transmission device
91 Frequency adjustment unit
100 Optical reception device
101 Frequency offset detection unit
110 Optical transmission device
111 Light source unit
120 Optical reception device
121 Local oscillation light output unit
122 Frequency offset detection unit
123 Frequency adjustment unit
201 Communication channel
202 Communication channel
203 Communication channel

1. An optical transmission device comprising:
a light output unit configured to output light of a frequency allocated to the optical transmission device;
a light modulation unit configured to separate the light output by the light output unit into mutually orthogonal polarized waves, modulate an in-phase component and a quadrature component in each of the polarized waves, and output an optical signal acquired by polarization synthesis of modulated component waves;
a reception information acquisition unit configured to acquire information on a reception state of the optical signal in an optical reception device being a transmission destination of the optical signal; and
a frequency adjustment unit configured to control, based on the information on the reception state, a frequency of the light to be output by the light output unit, and adjust a frequency offset being a difference between a frequency of the light output by the light output unit and a frequency of local oscillation light for use in coherent detection of the optical signal by the optical reception device.

2. The optical transmission device according to claim 1, wherein
the reception information acquisition unit acquires, as the information on the reception state, information on a number of errors in the optical signal, and
the frequency adjustment unit controls the frequency of the light to be output by the light output unit, in such a way as to minimize the number of errors.

3. The optical transmission device according to claim 1, further comprising
a frequency measurement unit configured to measure a frequency of the optical signal output from the light modulation unit, wherein
the reception information acquisition unit acquires information on the frequency of the local oscillation light from the optical reception device, and
the frequency adjustment unit controls, based on the frequency of the optical signal measured by the frequency measurement unit and the frequency of the local oscillation light acquired by the reception information acquisition unit, the frequency of the light to be output by the light output unit, in such a way that the frequency offset becomes a preliminarily set value.

4. The optical transmission device according to claim 1, wherein
the reception information acquisition unit acquires information indicating a difference between the frequency of the optical signal and the frequency of the local oscillation light being received from the optical reception device, and
the frequency adjustment unit controls, based on the difference, acquired by the reception information acquisition unit, between the frequency of the optical signal and the frequency of the local oscillation light being received from the optical reception device, the frequency of the light to be output by the light output unit, in such a way that the frequency offset becomes a preliminarily set value.

5. An optical reception device comprising:
a local oscillation light output unit configured to output local oscillation light of a frequency being set based on a frequency of an optical signal acquired by modulating, by an optical transmission device, an in-phase component and a quadrature component in each of orthogonal polarized waves;
an optical signal reception unit configured to combine the optical signal with the local oscillation light, and convert the combined signal into an electrical signal;
a demodulation unit configured to perform demodulation processing, based on the electrical signal converted by the optical signal reception unit; and
a local oscillation light adjustment unit configured to control, based on information on a reception state of the optical signal, a frequency of the local oscillation light to be output by the local oscillation light output unit, and adjust a frequency offset being a difference between the frequency of the optical signal and the frequency of the local oscillation light output by the local oscillation light output unit.

6. The optical reception device according to claim 5, wherein
the local oscillation light adjustment unit controls the frequency of the local oscillation light to be output by the local oscillation light output unit, in such a way as to minimize a number of errors detected by the demodulation unit.

7. The optical reception device according to claim 5, further comprising:
a local oscillation light measurement unit configured to measure the frequency of the local oscillation light output from the local oscillation light output unit; and
a transmission information acquisition unit configured to acquire information on the frequency of the optical signal from the optical transmission device, wherein
the local oscillation light adjustment unit controls, based on the frequency of the local oscillation light measured by the local oscillation light measurement unit and the frequency of the optical signal acquired by the transmission information acquisition unit, the frequency of the local oscillation light to be output by the local oscillation light output unit, in such a way that the frequency offset becomes a preliminarily set value.

8. The optical reception device according to claim 5, wherein
the local oscillation light adjustment unit controls, based on a difference between the frequency of the optical signal detected by the demodulation unit and the frequency of the local oscillation light, the frequency of the light to be output by the local oscillation light output unit, in such a way that the frequency offset becomes a preliminarily set value.

9. An optical communication system comprising:
the optical transmission device according to claim 1; and
the optical reception device being a transmission destination of the optical signal, wherein
the frequency adjustment unit of the optical transmission device adjusts, based on information on a reception state of the optical signal acquired from the optical reception device, a frequency offset being a difference from a frequency of light output by the light output unit.

10. An optical communication method comprising:
outputting light of a frequency allocated to an own device;
separating the output light into mutually orthogonal polarized waves, modulating an in-phase component and a quadrature component in each of the polarized waves, and outputting an optical signal acquired by polarization synthesis of modulated component waves;
acquiring information on a reception state of the optical signal in an optical reception device being a transmission destination of the optical signal; and
controlling, based on the information on the reception state, a frequency of the light to be output, and adjusting a frequency offset being a difference between the frequency of the light output and a frequency of local oscillation light for use in coherent detection of the optical signal by the optical reception device.

11. The optical communication method according to claim 10, wherein:
when acquiring the information on the reception state, acquiring, as the information on the reception state, information on a number of errors in the optical signal; and
when controlling the frequency of the light to be output, controlling the frequency of the light to be output, in such a way as to minimize the number of errors.

12. The optical communication method according to claim 10, further comprising:
measuring a frequency of the output optical signal, wherein:
when acquiring the information on the reception state, acquiring information on the frequency of the local oscillation light from the optical reception device; and
when controlling the frequency of the light to be output, controlling, based on the measured frequency of the optical signal and the acquired frequency of the local oscillation light, the frequency of the light to be output, in such a way that the frequency offset becomes a preliminarily set value.

13. The optical communication method according to claim 10, wherein:
when acquiring the information on the reception state, acquiring information indicating a difference between the frequency of the optical signal and the frequency of the local oscillation light being received from the optical reception device; and
when controlling the frequency of the light to be output, controlling, based on the acquired difference between the frequency of the optical signal and the frequency of the local oscillation light being received from the optical reception device, the frequency of the light to be output, in such a way that the frequency offset becomes a preliminarily set value.

14. The optical communication method according to claim 10, further comprising:
outputting the local oscillation light of a frequency being set based on a frequency of an optical signal acquired by modulating, by an optical transmission device, an in-phase component and a quadrature component in each of orthogonal polarized waves;
combining the received optical signal with the local oscillation light, and converting the combined signal into an electrical signal;
performing demodulation processing, based on the converted electrical signal;
controlling, based on information on a reception state of the optical signal, the frequency of the local oscillation light to be output; and
adjusting a frequency offset being a difference between the frequency of the optical signal and the frequency of the local oscillation light.

15. An optical communication system comprising:
the optical transmission device according to claim 2; and
the optical reception device being a transmission destination of the optical signal, wherein
the frequency adjustment unit of the optical transmission device adjusts, based on information on a reception state of the optical signal acquired from the optical reception device, a frequency offset being a difference from a frequency of light to be output by the light output unit.

16. An optical communication system comprising:
the optical transmission device according to claim 3; and
the optical reception device being a transmission destination of the optical signal, wherein
the frequency adjustment unit of the optical transmission device adjusts, based on information on a reception state of the optical signal acquired from the optical reception device, a frequency offset being a difference from a frequency of light to be output by the light output unit.

17. An optical communication system comprising:
the optical transmission device according to claim 4; and
the optical reception device being a transmission destination of the optical signal, wherein
the frequency adjustment unit of the optical transmission device adjusts, based on information on a reception state of the optical signal acquired from the optical reception device, a frequency offset being a difference from a frequency of light to be output by the light output unit.

18. The optical communication method according to claim 11, further comprising:
outputting the local oscillation light of a frequency being set based on a frequency of an optical signal acquired by modulating, by an optical transmission device, an in-phase component and a quadrature component in each of orthogonal polarized waves;
combining the received optical signal with the local oscillation light, and converting the combined signal into an electrical signal;
performing demodulation processing, based on the converted electrical signal;
controlling, based on information on a reception state of the optical signal, the frequency of the local oscillation light to be output; and
adjusting a frequency offset being a difference between the frequency of the optical signal and the frequency of the local oscillation light.

19. The optical communication method according to claim 12, further comprising:
outputting the local oscillation light of a frequency being set based on a frequency of an optical signal acquired by modulating, by an optical transmission device, an in-phase component and a quadrature component in each of orthogonal polarized waves;
combining the received optical signal with the local oscillation light, and converting the combined signal into an electrical signal;
performing demodulation processing, based on the converted electrical signal;
controlling, based on information on a reception state of the optical signal, the frequency of the local oscillation light to be output; and
adjusting a frequency offset being a difference between the frequency of the optical signal and the frequency of the local oscillation light.

20. The optical communication method according to claim 13, further comprising:
outputting the local oscillation light of a frequency being set based on a frequency of an optical signal acquired by modulating, by an optical transmission device, an in-phase component and a quadrature component in each of orthogonal polarized waves;
combining the received optical signal with the local oscillation light, and converting the combined signal into an electrical signal;
performing demodulation processing, based on the converted electrical signal;
controlling, based on information on a reception state of the optical signal, the frequency of the local oscillation light to be output; and
adjusting a frequency offset being a difference between the frequency of the optical signal and the frequency of the local oscillation light.
